(19) United States
(12) Patent Application Publication
(10) Pub. No.: US 2024/0317290 A1
(43) Pub. Date: Sep. 26, 2024

(54) OMNI-DIRECTIONAL STACKABLE NESTING UTILITY CART

(71) Applicant: Lab67 Co., Las Vegas, NV (US)

(72) Inventor: David Bruce McCalib, JR., Ridgefield, WA (US)

(73) Assignee: Lab67 Co., Las Vegas, NV (US)

(21) Appl. No.: 18/611,380

(22) Filed: Mar. 20, 2024

Related U.S. Application Data
(60) Provisional application No. 63/500,384, filed on May 5, 2023.
(60) Provisional application No. 63/491,124, filed on Mar. 20, 2023.

(51) Int. Cl. B62B 3/16; B62B 3/00; B62B 3/02

(52) U.S. Cl. CPC B62B 3/16; B62B 3/002; B62B 3/02; B62B 2301/25

(57) ABSTRACT

A nesting utility cart is disclosed comprising wheels fixed to a cart deck. The cart decks may stack on top of each other such that at least a portion of the wheels of an overlaying similar cart deck may protrude below the bottom surface of the cart deck that it overlays. The protrusion of wheels through the cart deck may lock all of the stacked cart decks together. Tubing and netting may be fixed to the cart decks to form side walls securing cargo on the nesting utility cart.

### CROSS-REFERENCE TO RELATED APPLICATIONS

This application claims the benefit of U.S. provisional patent application Ser. No. 63/500,384, filed on May 5, 2023, and the benefit of U.S. provisional patent application Ser. No. 63/491,124, filed on Mar. 20, 2023, each of which is incorporated herein by reference in its entirety.

### BACKGROUND

Outbound (OB) loading of trailers with product at Distribution Centers (DCs) and the unloading of these trailers at stores or other destinations may employ a product transport method of floor loading product in trailers, which is characterized by a number of inefficiencies. Floor loaded trailers may take two and a half hours to unload, even using gravity rollers. Pallets may need to be unloaded to a back room or stockroom until their inventory has been sorted, loaded onto rolling carts stored onsite, and moved out into the destination site to be shelved, which may take three to four hours. The stockroom may already be partially or mostly full of inventory, the rolling carts, and other equipment.

Using rolling carts throughout this process may provide a significant boost in labor productivity, as rolling carts may be easily on- and off-loaded to/from trailers and then rolled into stores or other destinations for direct unloading onto storage shelves. The use of these rolling carts may represent an improvement over the use of traditional pallets. Conventional rolling carts, however, lack the compact stackability, stacked stability, and transport stability of traditional pallets.

There is therefore a need for a rolling cart that stacks safely and compactly and may be transported safely in a truck or shipping container across long distances.

### BRIEF SUMMARY

In one aspect, a nesting utility cart (NUC) includes a cart deck having a first portion and a second portion, at least two wheels each secured to opposing sides of the first portion of the cart deck, and at least two wheels each secured to opposing sides of the second portion of the cart deck. The nesting utility cart further includes at least two orifices each through opposing sides of the first portion of the cart deck, and at least two orifices each through opposing sides of the second portion of the cart deck. The orifices are dimensioned to accept at least a portion of similar wheels of an overlaying similar cart deck. The at least two orifices in the first portion of the cart deck and the at least two orifices in the second portion of the cart deck are in a position to receive the similar wheels of the similar cart deck when the overlaying similar cart deck is nested in a reverse manner with respect to the first portion and second portion of the cart deck. The similar wheels of the similar cart deck nest within the at least two orifices in the first portion of the cart deck and the at least two orifices in the second portion of the cart deck. Each similar wheel protrudes below a bottom surface of the cart deck.

In one aspect, a system is disclosed which includes a stack of a plurality of the nesting utility carts disclosed herein.

In one aspect, a method of securely and compactly stacking the plurality of the nesting utility carts is disclosed which includes providing a first of the disclosed nesting utility carts, The method also includes providing a second nesting utility cart that is substantially similar to the first nesting utility cart. The method also includes orienting the second nesting utility cart in the reverse manner to an orientation of the first nesting utility cart. The method also includes placing the second nesting utility cart onto the first nesting utility cart such that the wheels of the second nesting utility cart protrude below the bottom surface of the cart deck of the first nesting utility cart.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a conventional collapsible rolling cart 100.

FIG. 2 illustrates a conventional stacking utility cart 200.

FIG. 3A and FIG. 3B illustrate a conventional nesting utility carts 300.

FIG. 4A and FIG. 4B illustrate user needs across a shipping cart use cycle 400 in accordance with one embodiment.

FIG. 5A-FIG. 5C illustrate a NUC 500 without netting installed in accordance with one embodiment. FIG. 5A shows a front elevation view, FIG. 5B illustrates a left elevation view, and FIG. 5C illustrates an isometric view.

FIG. 5D-FIG. 5E illustrate the NUC 500 in accordance with one embodiment. FIG. 5D illustrates a right side elevation view and FIG. 5E shows a front elevation view.

FIG. 5F illustrates an exploded view of the NUC 500 in accordance with one embodiment.

FIG. 6 illustrates a datum flow chain for NUC components 600 in accordance with one embodiment.

FIG. 7 illustrates a bottom plan view for a nesting cart deck design 700 in accordance with one embodiment.

FIG. 8 illustrates a bottom plan view for a nesting cart deck design 800 in accordance with one embodiment.

FIG. 9 illustrates a bottom plan view for a nesting cart deck design 900 in accordance with one embodiment.

FIG. 10 illustrates a bottom plan view for a nesting cart deck design 1000 in accordance with one embodiment.

FIG. 11 illustrates a routine 1100 in accordance with one embodiment.

FIG. 12A illustrates a left elevation view and FIG. 12B an isometric view of three cart decks stacked together 1200 in accordance with one embodiment.

FIG. 13A illustrates a front elevation view and FIG. 13B a left elevation view of eleven cart decks stacked together 1300 in accordance with one embodiment.

FIG. 14 illustrates an isometric view of a cart deck lengthwise cross-section showing wheel nesting details 1400 in accordance with one embodiment.

FIG. 15 illustrates a cart deck widthwise cross-section showing wheel nesting details 1500 in accordance with one embodiment.

FIG. 16 illustrates exemplary stack density 1600 in accordance with one embodiment.

FIG. 17 illustrates a top and bottom view of a cart deck 1700 in accordance with one embodiment.

FIG. 18 illustrates a cart deck with installed wheel brackets 1800 in accordance with one embodiment.

FIG. 19A-FIG. 19D illustrate cart decks engaged by conventional pallet jacks 1900 in accordance with one embodiment. FIG. 19A illustrates a bottom plan view, FIG. 19B and FIG. 19C illustrate isometric views, and FIG. 19D illustrates a front elevation view with multiple pallet jack sizes indicated.

FIG. 20 illustrates omnidirectional wheel movement degrees of freedom 2000 in accordance with one embodiment.

FIG. 21 illustrates a NUC side wall tube frame configuration 2100 in accordance with one embodiment.

FIG. 22A-FIG. 22C illustrate a cart deck with locking pins 2200 in accordance with one embodiment. FIG. 22A shows an isometric view of four cart decks stacked. FIG. 22B shows a detail view of locking pin and wheel bracket securement. FIG. 22C shows in greater detail an inserted locking pin.

FIG. 23A and FIG. 23B illustrate nesting utility cart side wall configurations 2300 in accordance with disclosed embodiments.

FIG. 24A-FIG. 24C illustrate a nesting utility cart with folding tube frame side walls 2400 in accordance with one embodiment. FIG. 24A shows an isometric view, FIG. 24B slows a left elevation view, and FIG. 24C shows a top plan view.

FIG. 25 illustrates a nesting utility cart with collapsible side walls 2500 in accordance with one embodiment.

FIG. 26 illustrates nesting utility carts with collapsible side walls configured for storage or stacked transport 2600 in accordance with one embodiment.

FIG. 27 illustrates a locking floor brake 2700.

FIG. 28 illustrates a floor brake locking mechanism configuration 2800.

FIG. 29 illustrates a dual wheel foot brake locking mechanism configuration 2900.

FIG. 30 illustrates individual wheel locking mechanism configuration for omnidirectional wheels 3000 in accordance with one embodiment.

FIG. 31A and FIG. 31B illustrate a conventional delivery routine 3100 in accordance with one embodiment.

FIG. 32A and FIG. 32B illustrate a NUC delivery routine 3200 in accordance with one embodiment.

FIG. 33 illustrates recommended NUC loading heights 3300 in accordance with one embodiment.

FIG. 34 illustrates NUC spacing and arrangement in a truck container 3400 in accordance with one embodiment.

FIG. 35 illustrates typical case sizes for two exemplary shippers 3500.

FIG. 36 illustrates a cart analysis worst case for first shipper 3600 in accordance with one embodiment.

FIG. 37 illustrates a cart analysis best case for second shipper 3700 in accordance with one embodiment.

FIG. 38 illustrates a cart analysis average case for second shipper 3800 in accordance with one embodiment.

FIG. 39 illustrates a cart analysis worst case for second shipper 3900 in accordance with one embodiment.

FIG. 40 illustrates a space analysis scenario for the first shipper 4000 in accordance with one embodiment.

FIG. 41 illustrates a space analysis scenario for the second shipper 4100 in accordance with one embodiment.

FIG. 42 illustrates exemplary material specifications 4200 in accordance with one embodiment.

FIG. 43 illustrates weight estimates for a NUC with removable side walls 4300 in accordance with one embodiment.

FIG. 44 illustrates exemplary NUC variants 4400 in accordance with one embodiment.

FIG. 45 illustrates exemplary worker health and safety data 4500 in accordance with one embodiment

### DETAILED DESCRIPTION

The disclosed is a special purpose Nesting Utility Cart (NUC) that may facilitate high density storage through quick and easy disassembly and secure, compact stacking in a nesting manner. The disclosed utility cart may be referred to throughout this application as “NUC,” nesting utility cart, or “cart” interchangeably for the sake of simplicity. Unless otherwise indicated, “cart” refers to the disclosed design. These carts may need to be disassembled for stacked storage. However, disassembly may be made easy by NUC design.

The NUC vertical nesting may be very useful in tight storage commonly found in the back of stock rooms, and retail locations. Uses for the NUC relate to general material handling of cases and other large or heavy items commonly found in retail restocking, beverage handling, mail handling, and other material handling roles. The carts may be stacked and nested, the wheels nesting through the decks. This may provide better stacking density and may lock the entire cart stack together. The cart may have side walls that include tubes inserted into holes or slots. This may allow the side frames to be rigid but removable, providing a flat deck that may be stacked.

The cart may primarily be used in retail distribution centers where it may be loaded with the outbound flow of materials from the DC in a manner in which the retail store may be restocked. The flow of materials typically goes to an outbound shipping lane conveyor. A human picks the boxes up and stacks them in the NUC. The NUCs are loaded into a shipping semi-truck. In one embodiment, 13 rows and 4 columns, or 52 NUCs, may fit inside a standard 53′ trailer. Once arrived at the retail location, a driver may pull them out in sequence onto a lift gate and lower them to the ground. The NUCs may be designed to be 24″ wide by 48″ long by 68″ tall in order to fit through a man door.

Once inside a retail store backroom, they may be taken directly to the aisle where the cases may be unloaded directly to the shelf. Once the NUC is empty, it may be taken back into the backroom and disassembled and stacked for storage. The cart decks and wheels may be stacked and nested securely on top of each other, and the frames may be stacked into an assembled cart.

In one embodiment, a stacking density of one base cart deck to every seven decks, with one base cart deck holding six frames, may be easily achieved, for an average 1:6 reduction in storage volume for the same footprint. Once the carts are stacked and nested, 600% in space savings may be achieved.

The reverse logistics of taking the carts back into the trailers is done by rolling the stacked carts onto the back of a long haul 53′ truck with a lift gate. Lift gates may range from 80″ wide to 89″ wide and 30″ deep to 70″ deep. However since the carts stack vertically, roughly thirty carts may be brought up at one time with each lift gate cycle, and the long haul truck may store the carts with high density.

In one embodiment, the cart may have removable side walls. In another embodiment, the cart may have collapsible side walls. In addition to comparisons of cost and weight between these two design directions, the major trade-off between the two is empty cart stack density versus case of use/setup/storage. Both designs may be easy to use and stackable, but there are advantages to each design.

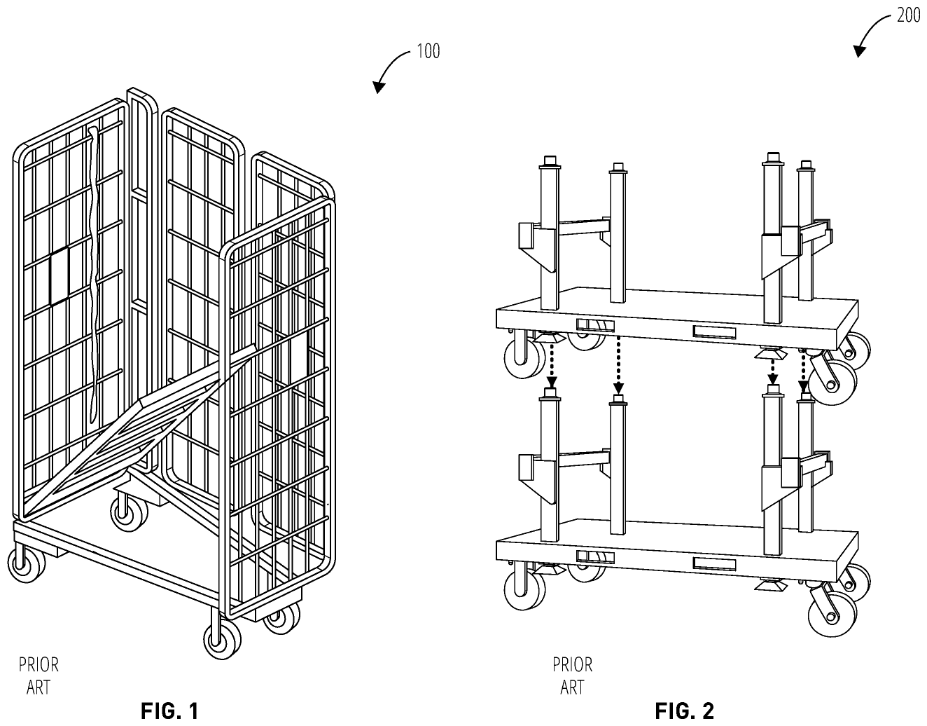

FIG. 1 illustrates a conventional collapsible rolling cart 100. Such a cart may be collapsed for dense storage and rolled for transport.

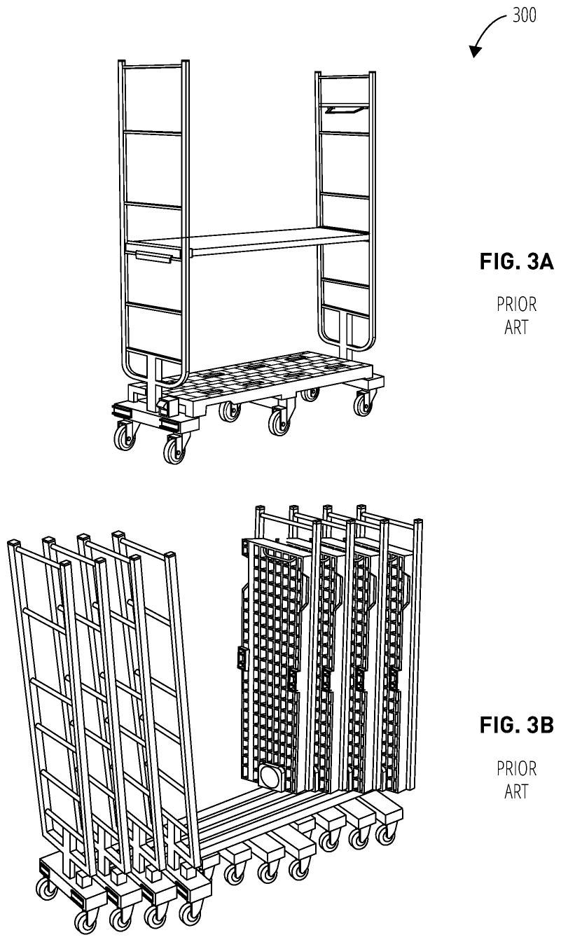

FIG. 2 illustrates a conventional stacking utility cart 200. Such a cart may have vertical stacking density that is very low. Examples may include the carts typically used in mail sorting.

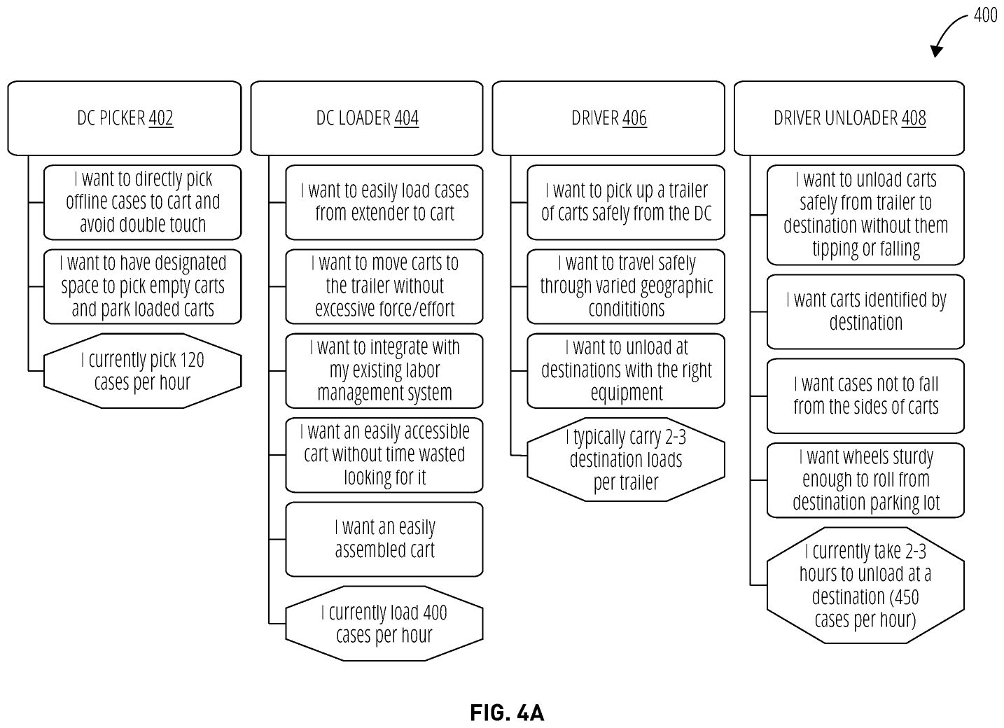

FIG. 3A and FIG. 3B illustrate conventional nesting utility carts 300. Such carts may have low nesting density.

The conventional solutions illustrated in FIG. 1-FIG. 3B and described herein may thus be seen to fail in meeting the need for dense, secure storage of robust, maneuverable utility carts, which issues the disclosed solution overcomes, representing a marked technical improvement over conventional solutions.

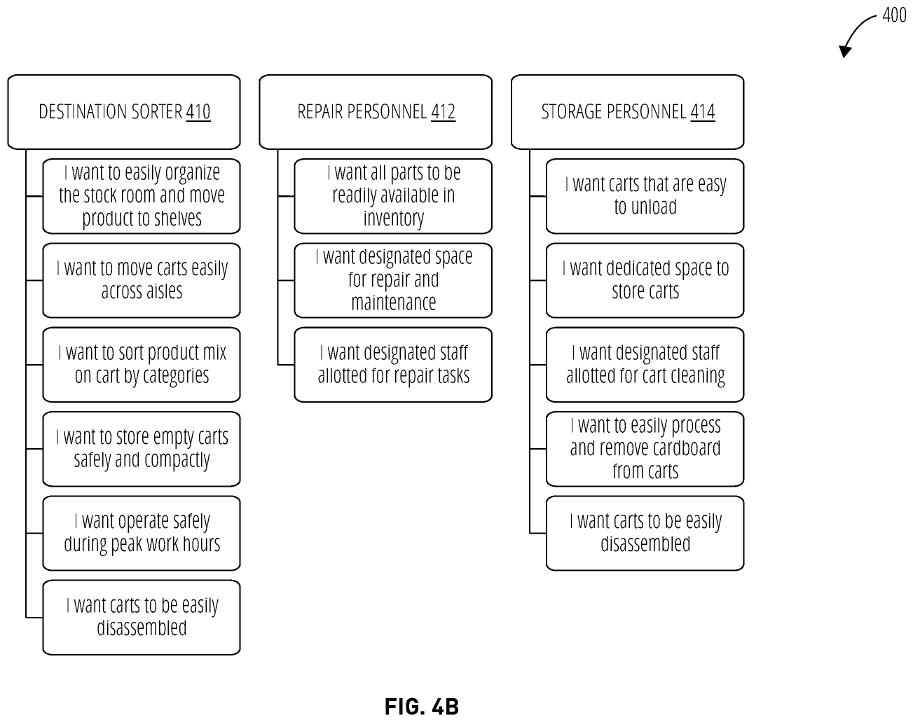

FIG. 4A and FIG. 4B illustrate user needs across a shipping cart use cycle 400 in accordance with one embodiment. Typical users involved in the NUC use cycle are distribution center pickers 402, distribution center loaders 404, drivers 406, driver unloaders 408, destination sorters 410, repair personnel 412, and storage personnel 414. Each user may prioritize different attributes in a NUC and may have operational needs not currently satisfied by conventional solutions such as those illustrated in FIG. 1-FIG. 3B.

Distribution center pickers 402 may pick items from storage locations throughout a distribution center. Such workers may want to pick items, cases, and/or pallets directly to a cart to avoid handling picked each item twice, once when picked and once at the trailer or truck. They may wish to have designated spaces for obtaining empty carts and for parking loaded carts. Distribution center pickers 402 may pick 120 cases per hour.

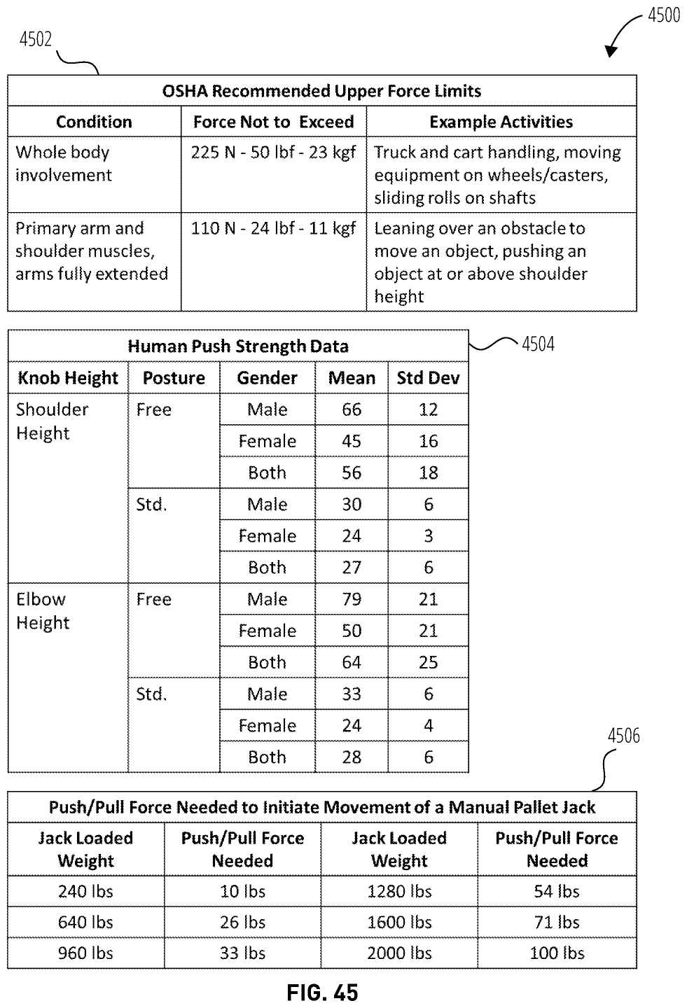

Distribution center loaders 404 may take picked items from conveyors and load them onto trailers for shipping, whether the items reside in carts or not. Such workers may want to easily load cases from extenders (conveyers) onto carts that they may then move to the trailer without exerting excessive force or effort, per worker health and safety regulations, exemplified by tables in FIG. 45. They may want the carts to readily integrate with labor management systems already in place. They may want the carts to be readily accessible and easy to find, so that time isn't wasted looking around for a cart when one is needed. They may wish carts to be easy to assemble. They may load 400 cases per hour onto carts and/or onto trailers.

Drivers 406 may drive loaded trailers from the distribution center to one or more destinations. They may wish to pick up trailers loaded with shipments from the distribution center in a manner that is safe for the driver and truck, as well as for the shipments carried. They may wish to be able to travel through diverse geographic conditions, including rough road, adverse weather, high altitude gradients, etc., in a manner that is safe for the driver and truck, as well as for the shipments carried. They may wish to be assured that they and/or the destinations have the correct equipment to unload a shipment. They may typically carry shipments for two or three different destinations in one trailer.

Driver unloaders 408 may travel with drivers 406 or may be drivers 406 and may be responsible for unloading the shipments upon arrival at each destination. Such workers may wish to be able to unload carts safely from the trailer to the destination stocking area, without carts tipping or falling. They may want each cart to be labeled or otherwise identified by destination. They may want carts that prevent items, cases, and/or pallets from falling off of the cart. They may want the cart wheels to be robust or sturdy enough, as well as maneuverable enough, that they may easily and safely roll the carts over parking lot terrain and into the destination site, without harm to themselves, the carts, or the items on the carts. They may take two to three hours to unload a shipment at a destination, at a rate of 450 cases per hour.

Destination sorters 410 may receive shipments at a destination and sort items, cases, and pallets into categories to facilitate efficient distribution to designated destination storage areas such as stock shelves. Such workers may wish to be able to easily organize the stock room or other receiving area and to readily move product to shelves so that products are ready for sale to customers. They may wish the carts to be easy to maneuver along and across store aisles, where space may be limited. They may want to receive carts that contain products pre-sorted by store categories. They may want to store empty carts safely and compactly, in a manner preventing carts from blocking aisles or becoming trip hazards. They may wish to be able to work with the carts safely even during peak hours, such that the carts do not cause undue inconvenience to shoppers in a store, for example. They may want carts to be easy to disassemble for more compact storage.

Repair personnel 412 may work at distribution centers or in locations where many carts are stored and deployed. Such workers may want carts to be constructed using easily found parts, and may wish for spare parts to all be readily available in an on-site inventory for use in repairing damaged carts. They may wish to have designated spaces in which to repair carts and perform maintenance tasks. They may wish to have or be part of a designated repair staff, well trained and knowledgeable about cart construction and operational tolerances.

Storage personnel 414 may work at distribution centers and may be responsible for unloading and stowing equipment and materials that come back on trailers after their shipments are delivered. Such workers may wish for carts to be easy to safely unload from a trailer. They may wish for a designated space where unloaded carts may be stored. They may which to have or be part of a designated cleaning staff, well trained in how to keep carts clean and in sound working order. They may wish for the carts to facilitate an easy process for removing cardboard returned on the trailer from the destinations. They may wish for carts to be easily disassembled for more compact storage.

It may be readily apprehended by one of ordinary skill in the art that the disclosed solution, as described and claimed below, may better satisfy the needs of each of these users more completely than conventional solutions currently available.

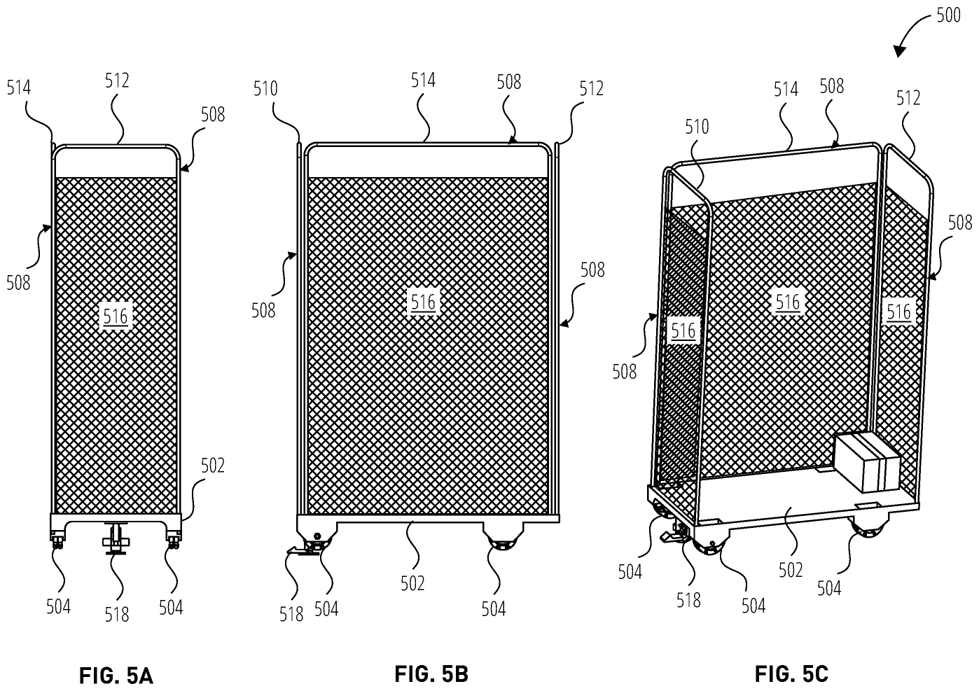

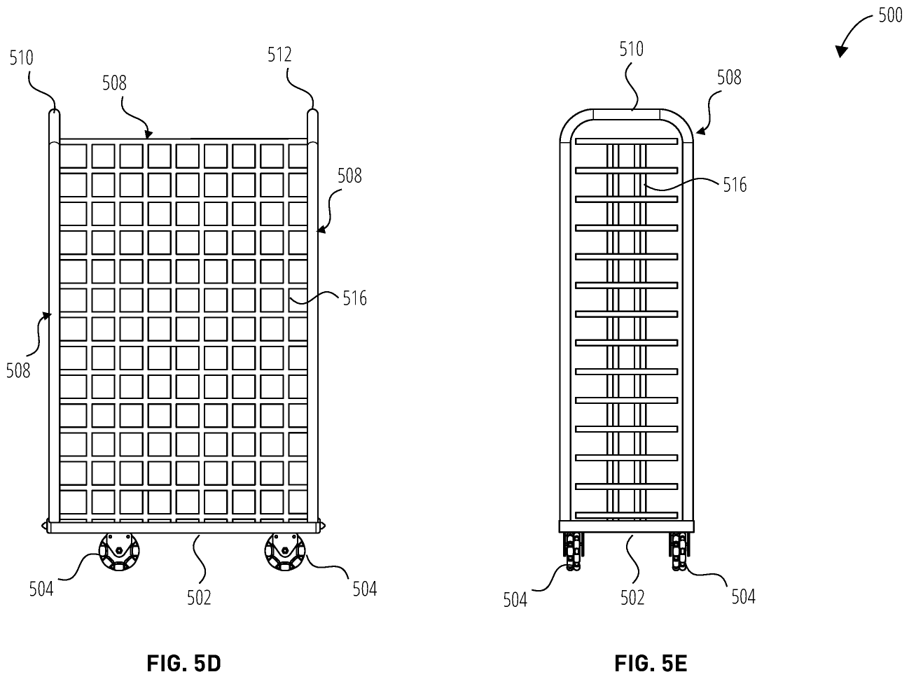

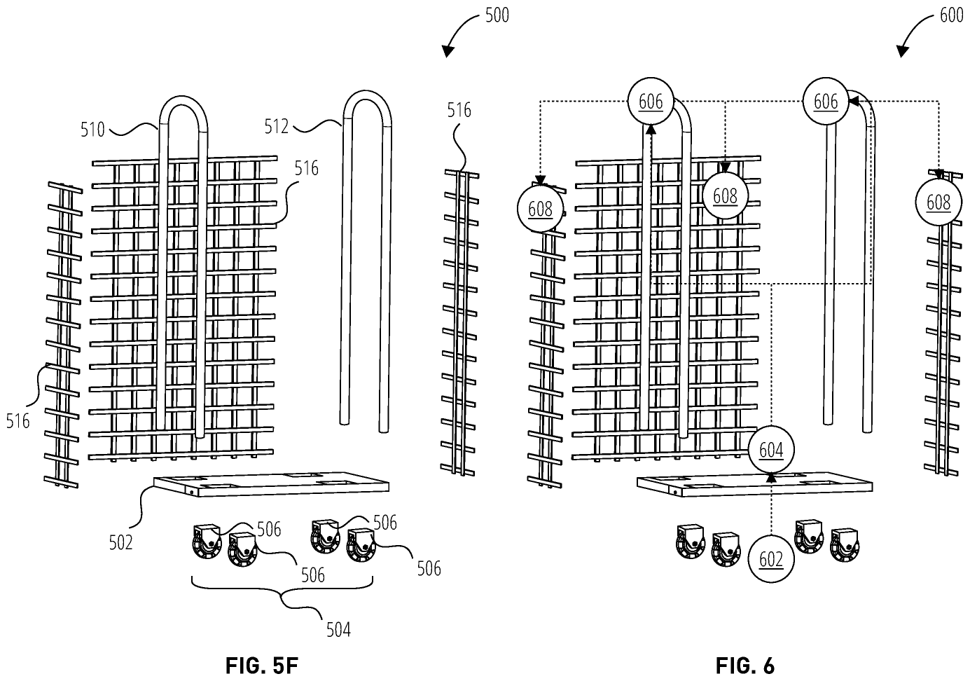

FIG. 5A-FIG. 5F illustrate a NUC 500 in accordance with one embodiment. FIG. 5A shows a front elevation view, FIG. 5B illustrates a left elevation view, FIG. 5C illustrates an isometric view, and FIG. 5F illustrates an exploded view. The NUC 500 may comprise a cart deck 502, wheels 504 fixed to the cart deck 502 with wheel brackets 506, removeable side walls 508 made of tube frames (such as the first tube frame 510, second tube frame 512, and third tube frame 514 shown) and netting 516, and a locking mechanism 518.

The cart deck 502 may be manufactured from various materials selected for strength, rigidity, durability, and/or lightness. In one embodiment, the cart deck 502 may be made through injection molding of plastic. Other suitable materials and methods of manufacture may be readily apparent to one of ordinary skill in the art. The cart deck 502 may be designed such that the removeable side wall 508 tube frames sit securely in the cart deck 502.

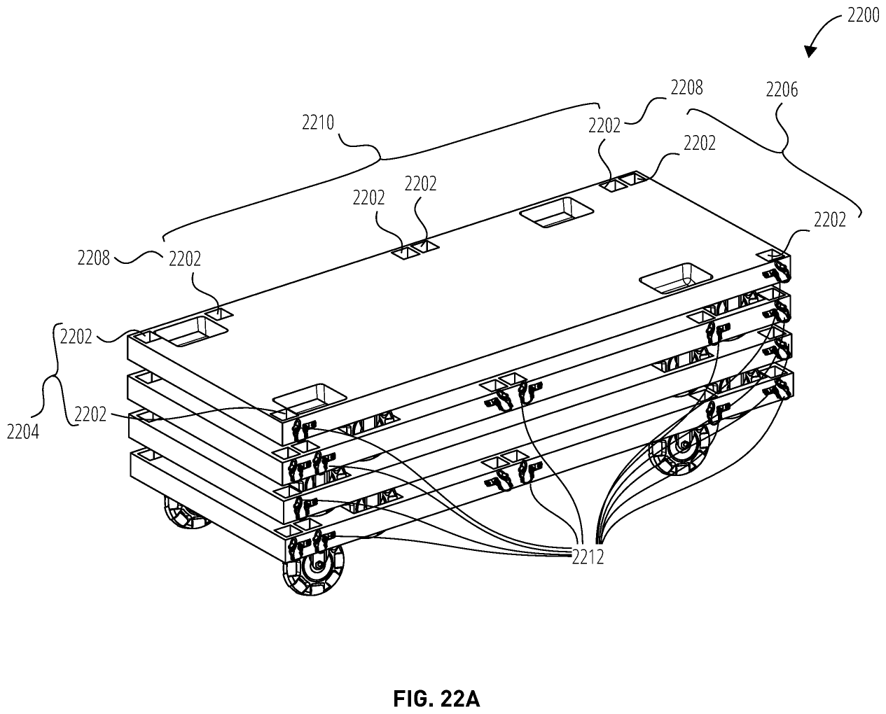

Wheels 504 may be manufactured from various materials selected for strength, durability, and/or lightness. In one embodiment, the wheels 504 may be omnidirectional wheels, such as that described with respect to FIG. 20, made through sequential injection molding assembly, with a final overmolding of a polyurethane. In one embodiment, a wheel 504 may have a 150 mm diameter and a custom bearing hub. Material may be removed from the wheel hub. Other suitable sizes, materials, and methods of manufacture may be readily apparent to one of ordinary skill in the art. Carts intended to carry from 1,000 to 2,000 pounds may be built using wheels in different configurations, including carts with five-wheel sets or carts having two to three rows of wheels per wheel set.

The removeable side walls 508 may be constructed using two tube frames (the first tube frame 510 and second tube frame 512, as shown) and netting 516. FIG. 5D-FIG. 5E illustrate the NUC 500 with netting installed in accordance with one embodiment. FIG. 5D illustrates a right side elevation view and FIG. 5E shows a front elevation view. first tube frame 510 for the NUC 500 may be manufactured from various materials and formed into various configurations selected for rigidity, strength, durability, and/or lightness. In one embodiment, the first tube frame 510 may be manufactured through pushed extrusion of aluminum. Additionally, their profile may be developed such that the netting 516 may attach in a custom manner. Other suitable materials and methods of manufacture may be readily apparent to one of ordinary skill in the art.

Netting 516 for the removeable side walls 508 may be manufactured from various materials selected for durability, small packing volume, and/or lightness. Netting 516 may be made through injection molding or rotary roll-to-roll die cutting of plastic films. Different netting 516 configurations may be used depending on product needs. Custom netting 516 may be developed for specific applications. In one embodiment, netting 516 may be made from a round, bungee-type cordage. In another embodiment, netting 516 may be made from a flat nylon webbing. Bungee type netting may be lighter and may pack to a smaller size. Flat webbing may be easier to modify to specific sizes and may bow outward less when packages are loaded. Other suitable netting materials for the removeable side walls 508 may be readily apparent to one of ordinary skill in the art.

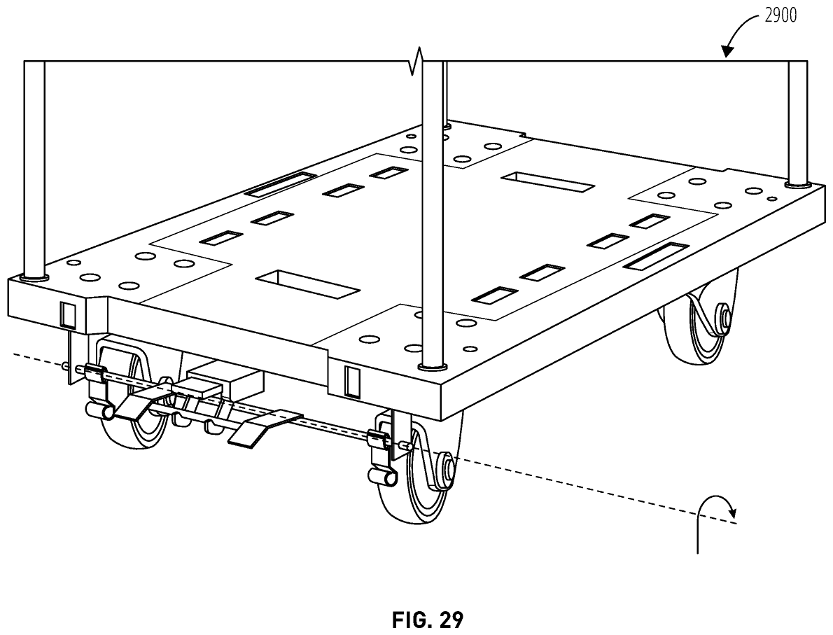

The locking mechanism 518 may be similar to the locking floor brake 2700 illustrated in FIG. 27, another locking configuration may be used, or the NUC 500 may be secured in place in some way other than the use of an integrated locking device. Additional locking options are discussed in greater detail elsewhere herein.

FIG. 5F illustrates an exploded view of these components of the NUC 500.

With regard to assembled cart dimensions, multiple embodiments of different aspect ratios may be manufactured to accommodate different materials, cargo, payload, etc., to be handled.

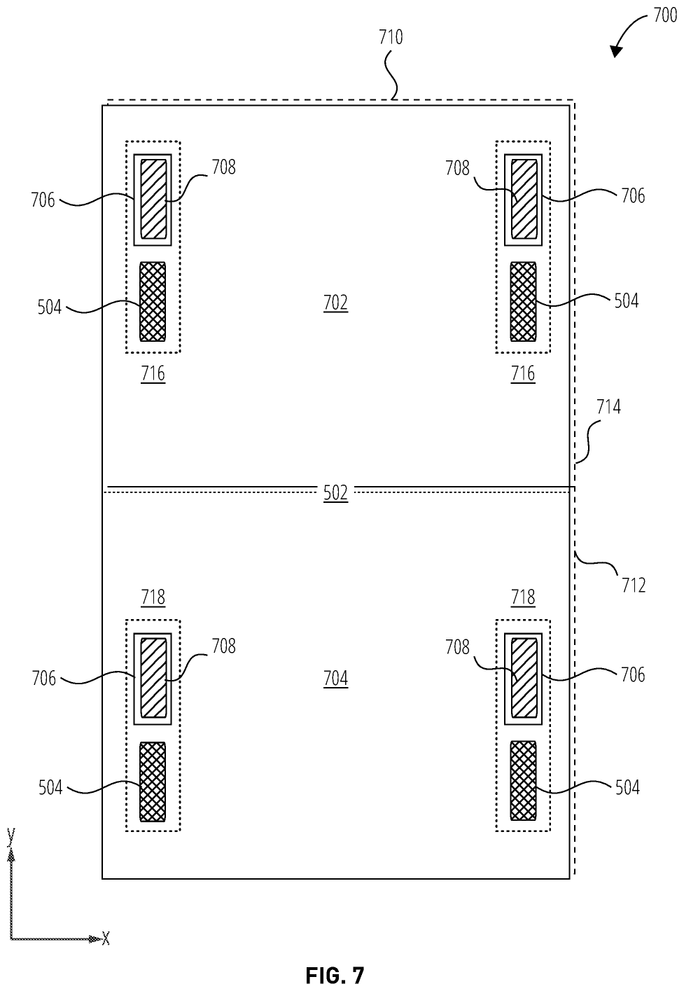

FIG. 6 illustrates a datum flow chain for NUC components 600 in accordance with one embodiment. This view shows the assembly steps provided in the datum flow chain for NUC components 600 overlaying the components of the NUC 500 as illustrated in FIG. 5F.

The wheels 504 assembled at step 602 attach primarily to the cart deck 502 at step 604. The removeable side walls 508 also attach to the cart deck 502 at step 606. The netting 516 attaches to the removeable side walls 508 at step 608.

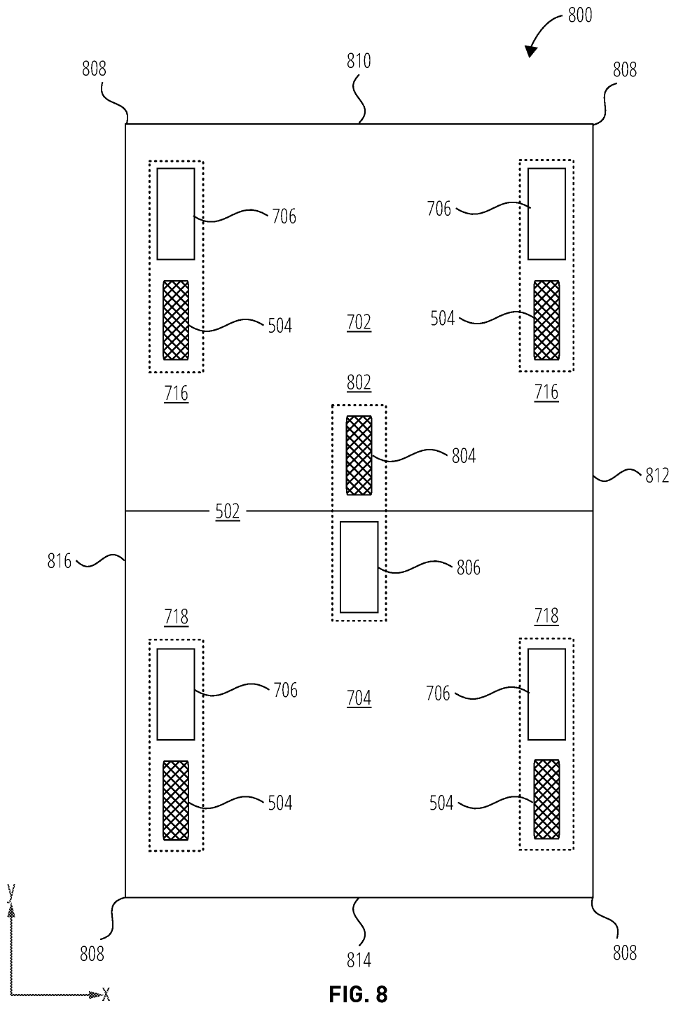

FIG. 7 illustrates a nesting cart deck design 700 in accordance with one embodiment. The nesting cart deck design 700 may configure a cart deck 502 to have a first portion 702 and second portion 704, wheels 504, and orifices 706.

At least two wheels 504 may each be secured to opposing sides of the first portion 702 of the cart deck 502, and at least two wheels 504 may each secured to opposing sides of the second portion 704 of the cart deck 502. In one embodiment, the wheels 504 may be omnidirectional wheels, and may be non-swiveling.

At least two orifices 706 may each run through opposing sides of the first portion 702 of the cart deck 502, and at least two orifices 706 may each run through opposing sides of the second portion 704 of the cart deck 502. The orifices 706 may be dimensioned and be in a position to accept at least a portion of similar wheel 708 of an overlaying similar cart deck 710 when the overlaying similar cart deck 710 (which may also have a first portion 712 and a second portion 714) is nested in a reverse manner with respect to the first portion 702 and second portion 704 of the cart deck 502. The similar wheel 708 of the overlaying similar cart deck 710 may thus nest within the at least two orifices 706 in the first portion 702 of the cart deck 502 and the at least two orifices 706 in the second portion 704 of the cart deck 502. Each similar omnidirectional wheel may protrude below a bottom surface of the cart deck.

“Similar cart deck” in this disclosure refers to a cart deck that is substantially similar to another cart deck with which it is intended to stack and nest. Substantially similar includes having similar dimensions, as well as a wheel layout pattern that is rotationally symmetrical with the orifice layout pattern of the cart deck with which it is intended to nest and stack, such that both cart decks may be securely and compactly stacked with each other when the similar cart deck is oriented in a reverse manner with respect to the cart deck with which it is intended to stack and nest.

The nesting cart deck design 700 may also have a first portion 702 that includes two first portion nesting assemblies 716, each first portion nesting assembly 716 including one wheel 504 adjacent to one orifice 706. The nesting cart deck design 700 may also have a second portion 704 that includes two second portion nesting assemblies 718, each second portion nesting assembly 718 including one wheel 504 adjacent to one orifice 706.

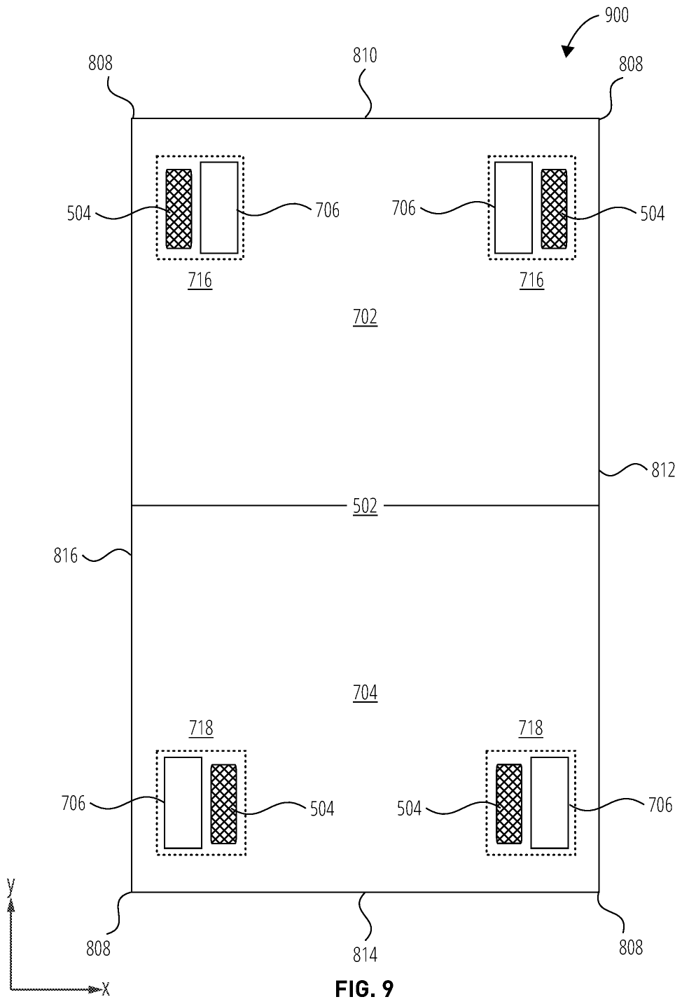

FIG. 8 illustrates a nesting cart deck design 800 in accordance with one embodiment. The nesting cart deck design 800 may configure a cart deck 502 having a first portion 702, a second portion 704, wheels 504, orifices 706, first portion nesting assemblies 716, second portion nesting assemblies 718, a centralized nesting assembly 802, a centralized wheel 804, a centralized orifice 806, corners 808, a first side 810, a second side 812, a third side 814, and a fourth side 816.

The nesting cart deck design 800 for the nesting utility cart may also include a centralized nesting assembly 802 including: one centralized wheel 804 adjacent to a centralized orifice 806, where at least one of the centralized wheel 804 is located in at least one of the first portion 702 and second portion 704, and the centralized orifice 806 is located in at least one of the first portion 702 and the second portion 704. The centralized omnidirectional wheel may also be located in the first portion 702 and the centralized orifice 806 in the second portion 704. The cart deck 502 may include two corners 808 in the first portion 702 and two corners 808 in the second portion 704, and each first portion nesting assembly 716 and each second portion nesting assembly 718 may be located in close proximity to a separate corner 808.

The cart deck 502 may include a first side 810, a second side 812, a third side 814, and a fourth side 816, where the first side 810 is in the first portion 702, the second side 812 is in the first portion 702 and the second portion 704, the third side 814 is in the second portion 704, and the fourth side 816 is in the first portion 702 and the second portion 704.

Each first portion nesting assembly 716 may be configured with its orifice 706 closer to the first side 810 than its wheel 504. Each second portion nesting assembly 718 may be configured with its wheel 504 closer to the third side 814 than its orifice 706.

Both the first portion nesting assembly 716 wheel 504 and the first portion nesting assembly 716 orifice 706 may be substantially equidistant from the second side 812 or the fourth side 816. Both the second portion nesting assembly 718 wheel 504 and the second portion nesting assembly 718 orifice 706 may be substantially equidistant from the second side 812 or the fourth side 816. Such configurations may be seen FIG. 8.

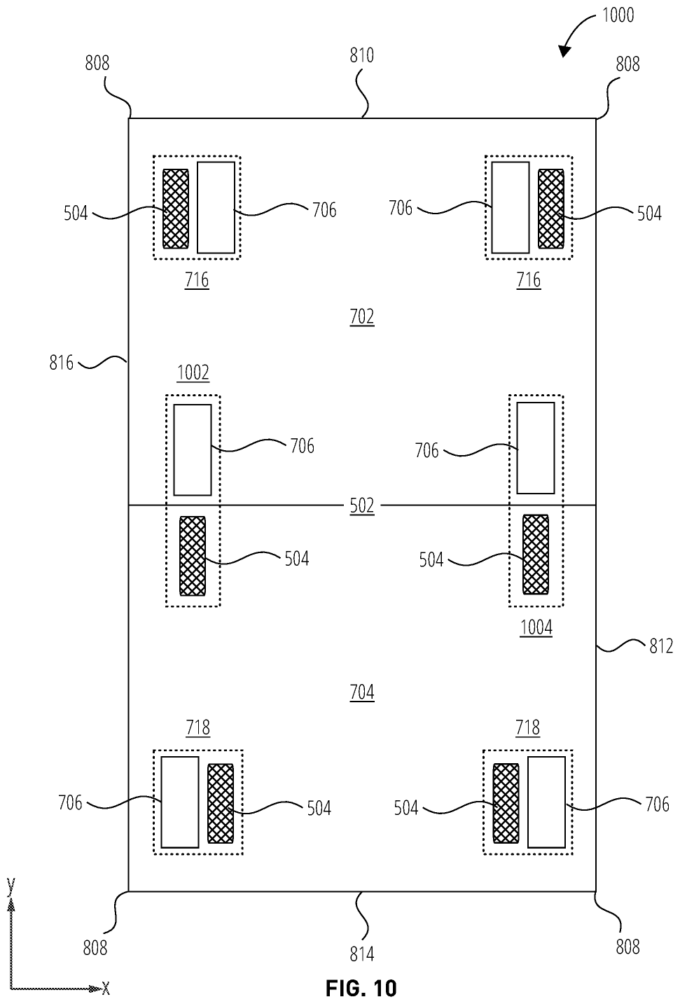

FIG. 9 illustrates a nesting cart deck design 900 in accordance with one embodiment. The nesting cart deck design 900 may configure a cart deck 502 having a first portion 702, a second portion 704, wheels 504, orifices 706, first portion nesting assemblies 716, second portion nesting assemblies 718, corners 808, a first side 810, a second side 812, a third side 814, and a fourth side 816.

The wheels 504 in the two first portion nesting assemblies 716 may be displaced from each other a greater distance than the wheels 504 of the two second portion nesting assemblies 718 are displaced from each other. Both the first portion nesting assembly 716 wheels 504 and the first portion nesting assembly 716 orifices 706 may not be equidistant from the second side 812 or the fourth side 816. Both the second portion nesting assembly 718 wheels 504 and the second portion nesting assembly 718 orifices 706 may not be equidistant from the second side 812 or the fourth side 816.

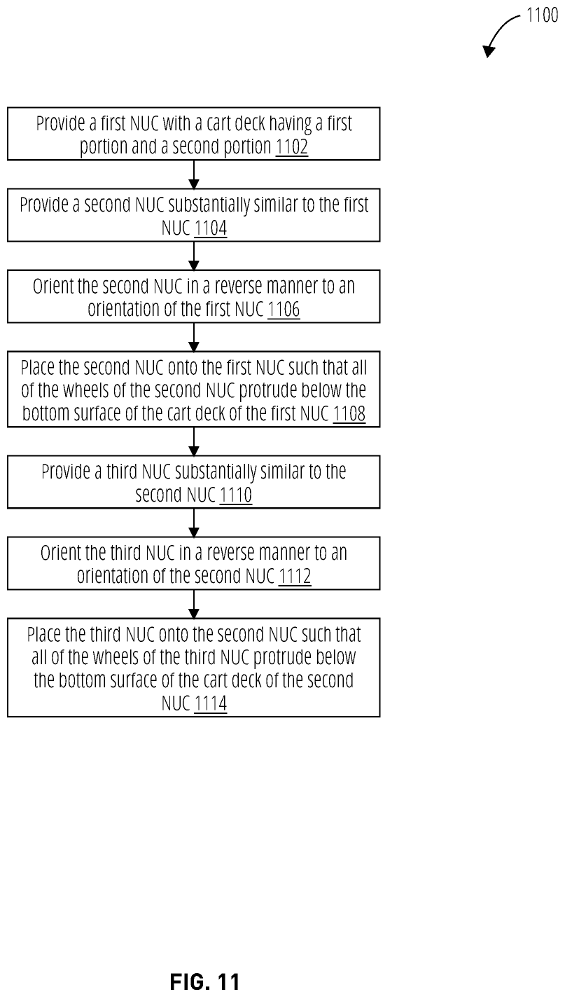

FIG. 10 illustrates a nesting cart deck design 1000 in accordance with one embodiment. The nesting cart deck design 1000 may configure a cart deck 502 having a first portion 702, a second portion 704, wheels 504, orifices 706, first portion nesting assemblies 716, second portion nesting assemblies 718, corners 808, a first side 810, a second side 812, a third side 814, and a fourth side 816.

The cart deck 502 of the nesting cart deck design 1000 may further include a first additional nesting assembly 1002, and a second additional nesting assembly 1004, each having one wheel 504 adjacent to one orifice 706, where at least one of the wheel 504 and the orifice 706 of the first additional nesting assembly 1002 is located in the first portion 702 and at least one of the wheel 504 and the orifice 706 of the first additional nesting assembly 1002 is located in the second portion 704. The cart deck 502 of the nesting cart deck design 1000 may be further configured such that at least one of the wheel 504 and the orifice 706 of the second additional nesting assembly 1004 is located in the first portion 702 and at least one of the wheel 504 and the orifice 706 of the second additional nesting assembly 1004 is located in the second portion 704.

While each of nesting cart deck designs 700-1000 illustrated in FIG. 7-FIG. 10 are shown as having two short sides and two long sides, with an aspect ratio of 3:5, it will be readily apparent to one of ordinary skill in the art that additional embodiments may have differing aspect ratios, including 1:1 for a square cart deck, or differing numbers of sides for, generally rectangular cart decks having side cutouts, or cart decks having other polygonal configurations, provided in each case that the locations of the orifices is rotationally symmetrical with the locations of the wheels, allowing secure and compact stacking in accordance with this disclosure. Other technical features may be readily apparent to one skilled in the art from the following figures, descriptions, and claims.

“Rotationally symmetrical” as used herein refers to an attribute of the layout pattern of the omnidirectional wheels and the layout pattern of orifices of the disclosed cart deck, wherein the center point for each wheel in the pattern of wheels may, within an appropriate dimensional tolerance overlay the center point of a corresponding orifice in the pattern of orifices when the pattern of wheels is rotated with respect to the pattern of orifices. For example, the pattern of wheels may, when rotated in a reverse manner, or by 180 degrees, overlay the pattern of orifices, allowing cart decks to nest securely when stacked or otherwise positioned one beside, behind, or on top of another. Rotational symmetry may be achieved for patterns rotated in increments of 90 degrees for rectangular carts, increments of 60 degrees for hexagonal carts, etc.

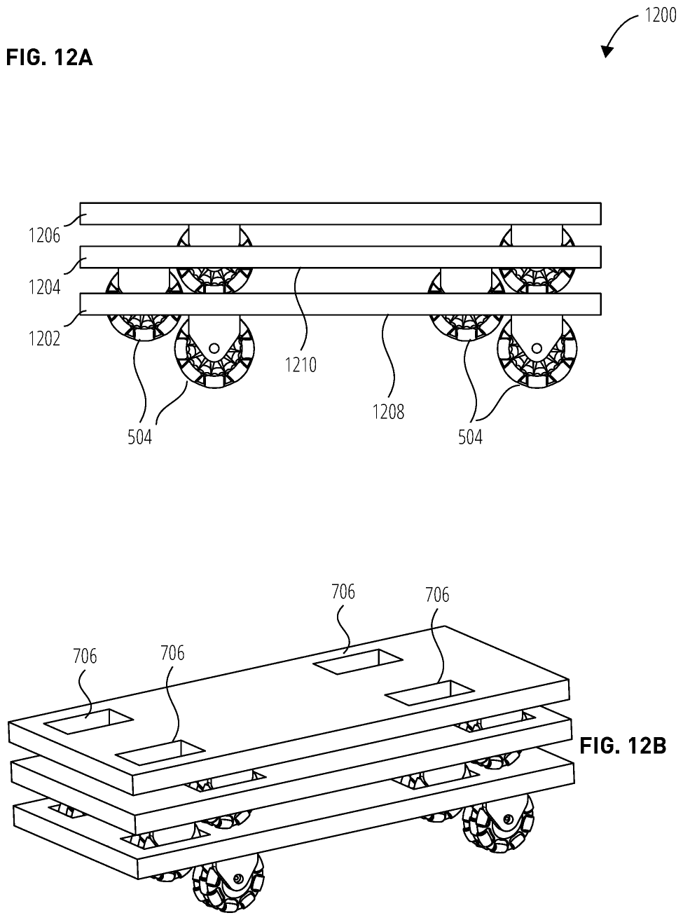

FIG. 11 illustrates an example routine 1100 for stacking the disclosed nested nesting utility carts (or, similarly, their cart decks). Although the example routine 1100 depicts a particular sequence of operations, the sequence may be altered without departing from the scope of the present disclosure. For example, some of the operations depicted may be performed in parallel or in a different sequence that does not materially affect the function of the routine 1100. In other examples, different components of an example device or system that implements the routine 1100 may perform functions at substantially the same time or in a specific sequence.

According to some examples, the method includes providing a first NUC with a cart deck having a first portion and a second portion at block 1102. This cart deck may be configured as is described with respect to FIG. 7-FIG. 10 and elsewhere herein. According to some examples, the method includes providing a second NUC substantially similar to the first NUC at block 1104. According to some examples, the method includes orienting the second NUC in a reverse manner to an orientation of the first NUC at block 1106.

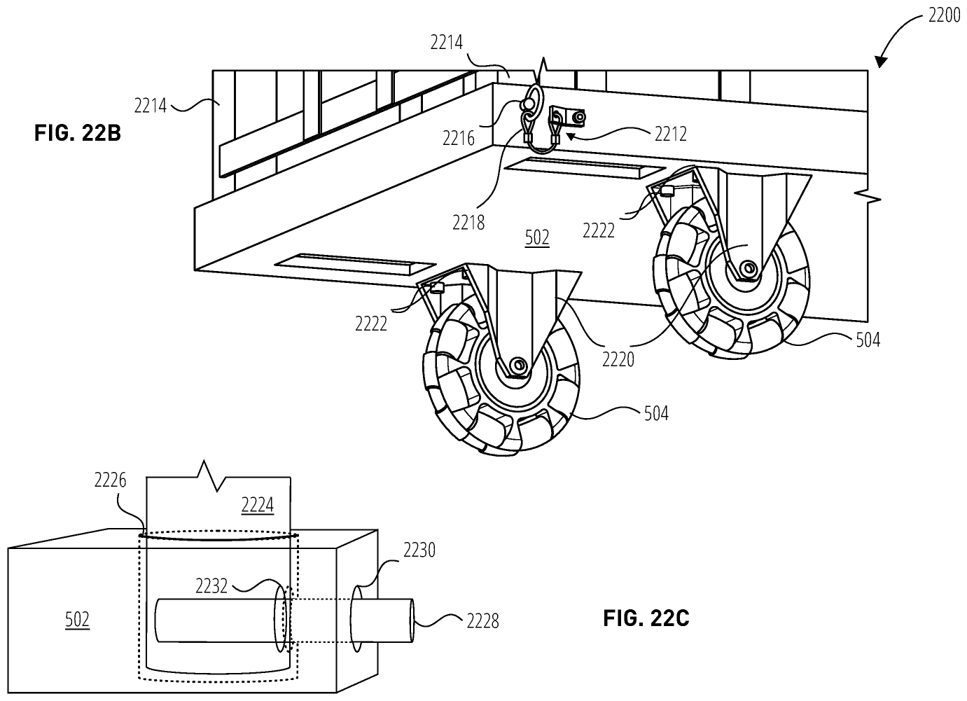

According to some examples, the method includes placing the second NUC onto the first NUC such that all of the wheels of the second NUC protrude below the bottom surface of the cart deck of the first NUC at block 1108. In one embodiment, the sidewalls from at least one of the first NUC and the second NUC may be removed before placing the second NUC onto the first NUC. These sidewalls may be as described with respect to FIG. 21 and elsewhere herein.

According to some examples, the method includes providing a third NUC substantially similar to the second NUC at block 1110. According to some examples, the method includes orienting the third NUC in a reverse manner to an orientation of the second NUC at block 1112. According to some examples, the method includes placing the third NUC onto the second NUC such that all of the wheels of the third NUC protrude below the bottom surface of the cart deck of the second NUC at block 1114.

One of ordinary skill in the art will recognize that blocks 1102-1108 may be repeated a number of times to form larger stacks of the disclosed nesting utility carts or their cart decks.

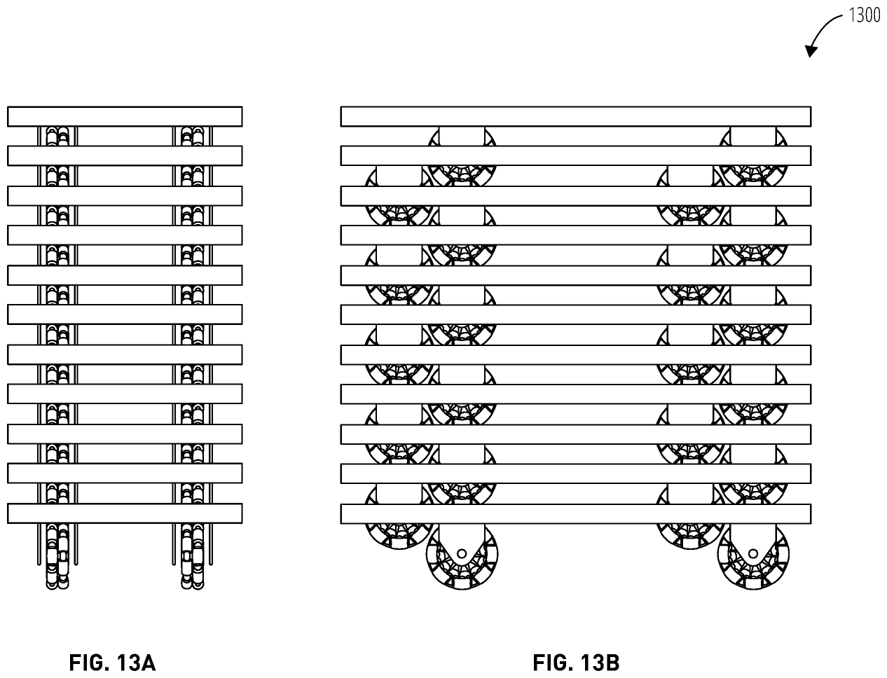

FIG. 12A illustrates a left elevation view and FIG. 12B an isometric view of three cart decks stacked together 1200 in accordance with one embodiment. The three cart decks stacked together 1200 may comprise a first cart deck 1202, a second cart deck 1204, and a third cart deck 1206, each configured with wheels 504, and each substantially similar to the others, as previously described.

The three cart decks stacked together 1200 may be positioned as described in the routine 1100 of FIG. 11. The first cart deck 1202 having wheels 504 and orifices 706 may have placed upon it, in a reverse manner, the substantially similar second cart deck 1204. The wheels 504 of the second cart deck 1204 may nest within the orifices 706 of the first cart deck 1202. The wheels 504 of the second cart deck 1204 may protrude below the bottom surface of the first cart deck 1208 as shown.

The second cart deck 1204 may then have placed upon it, in a reverse manner, the substantially similar third cart deck 1206. The wheels 504 of the third cart deck 1206 may nest within the orifices 706 of the second cart deck 1204. The wheels 504 of the third cart deck 1206 may protrude below the bottom surface of the second cart deck 1210. In this manner, the cart decks may form a stack of cart decks that is uniform in length and uniform in width, with no cart or carts significantly protruding out from the edges of the other carts, which may facilitate highly compact storage.

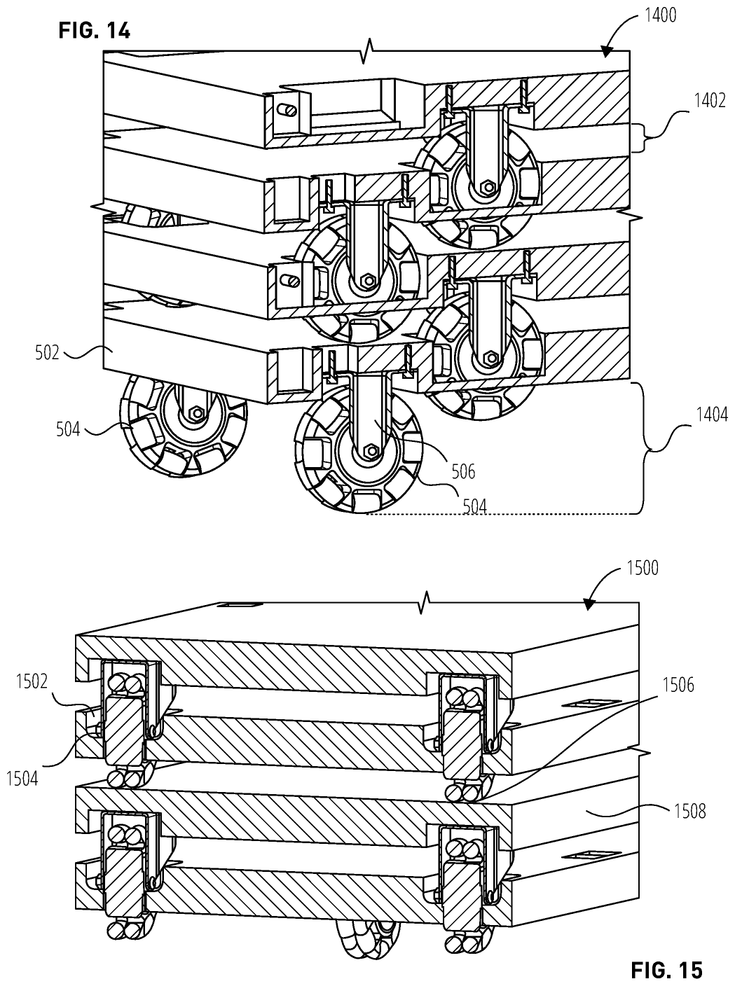

FIG. 13A illustrates a front elevation view and FIG. 13B a left elevation view of eleven cart decks stacked together 1300 in accordance with one embodiment. The stack height may be very tall, and all cart decks may be interlinked together.

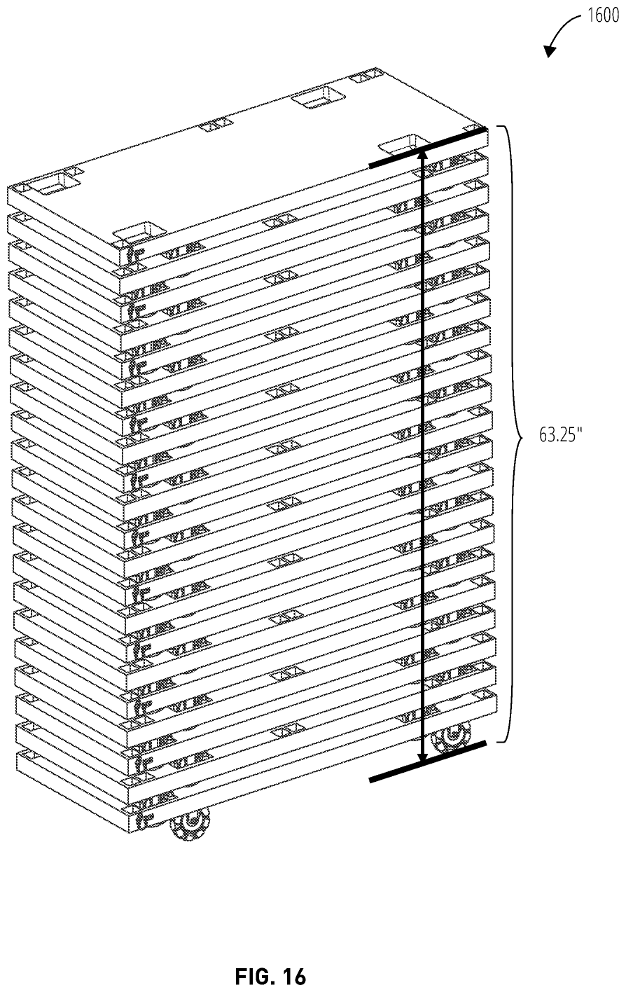

FIG. 14 illustrates an isometric view of a cart deck lengthwise cross-section showing wheel nesting details 1400 in accordance with one embodiment. Stack height may be limited by the wheel 504 diameter and wheel bracket 506 height. The illustrated stacking may achieve a 32 mm/1.25″ gap from deck to deck 1402. This may be reduced another 15 mm in one embodiment with a custom wheel bracket and deeper deck pocket. Higher ground clearance 1404 needs may impact stacking density. Rough surfaces such as gravel, etc., may necessitate 4″ ground clearance. With lower ground clearance, e.g., on the order of 0.25-0.5″, the asphalt the carts may be pushed over may need to be smooth and uniform. Very rough pavement, having large cracks, holes, etc., may be impassible by carts with this lower ground clearance.

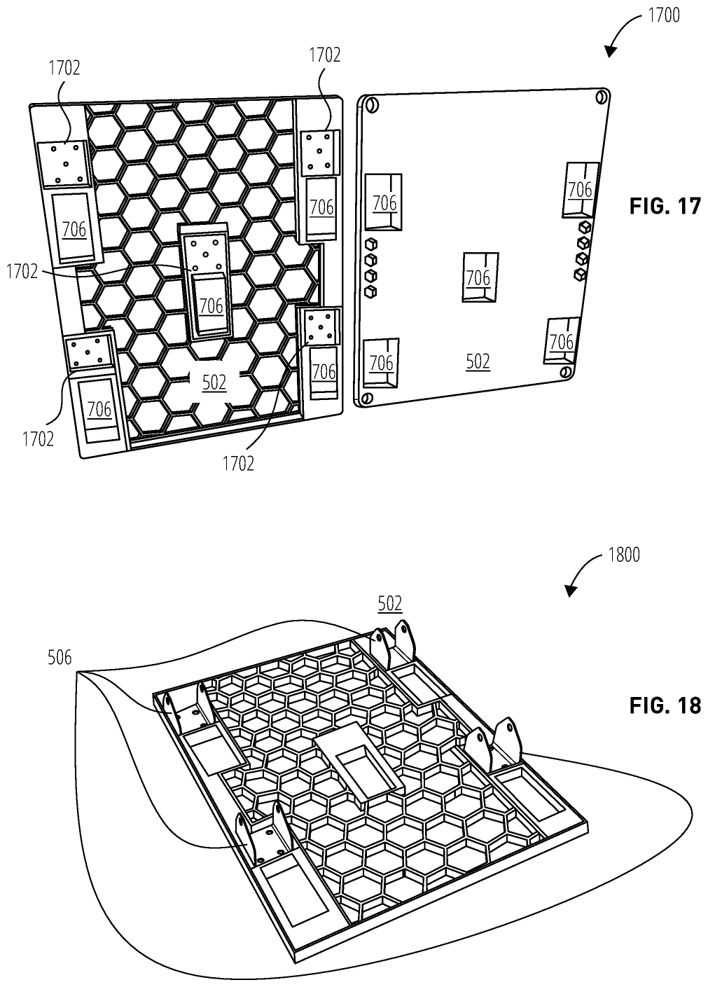

FIG. 15 illustrates an isometric view of a cart deck widthwise cross-section showing wheel nesting details 1500 in accordance with one embodiment. The flat surface of the wheel flange 1504 may bottom out in a cart deck pocket 1502. This may provide a uniform spacing throughout the stack. The wheel outer surface 1506 may contact the lower cart deck 1508 surface.

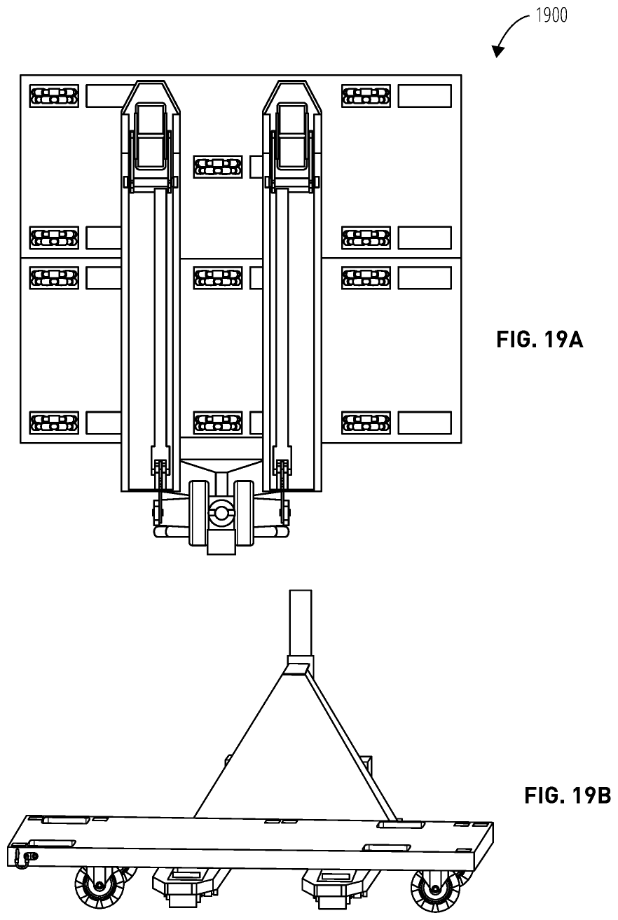

FIG. 16 illustrates exemplary stack density 1600 in accordance with one embodiment. Twenty-one cart decks may stack to a height of 63.25″.

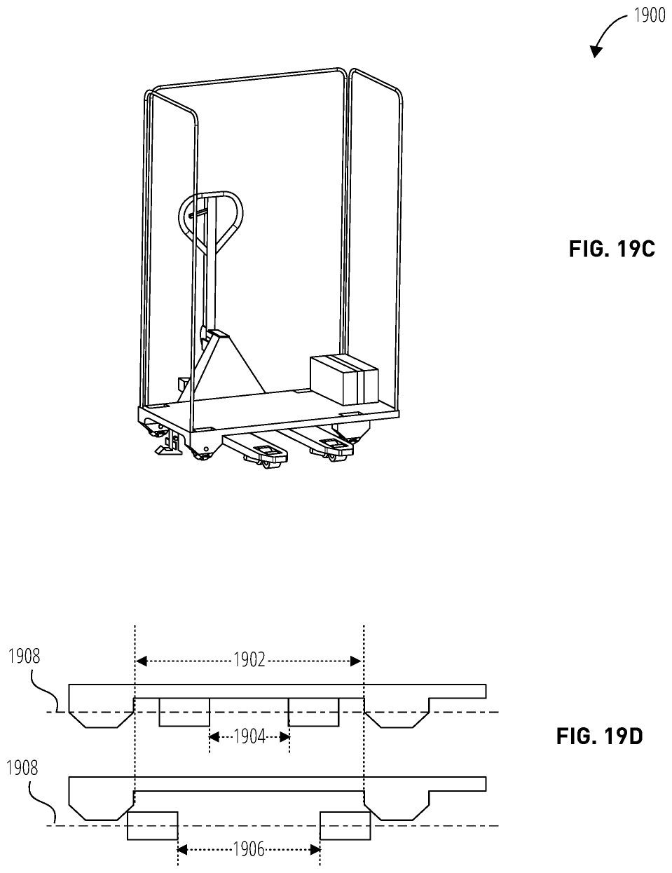

FIG. 17 illustrates a top and bottom view of a cart deck 1700 in accordance with one embodiment. Orifices 706 may be seen which may allow wheels on one cart deck 502 to protrude through another cart deck 502 when cart decks 502 are nested. The wheels may be mounted to the cart deck 502 by mounting brackets secured at the wheel bracket mounting cutouts 1702.

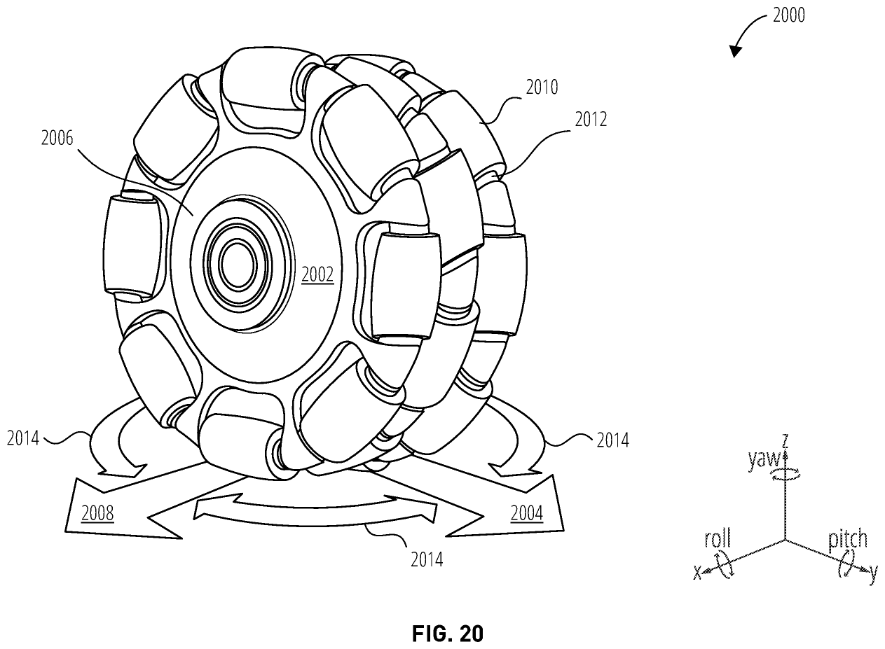

FIG. 18 illustrates a cart deck with installed wheel brackets 1800 in accordance with one embodiment. The wheel brackets 506 may attach to the cart deck 502 using plastic tapping screws. The wheel brackets 506 and orifices 706 may be arranged in the identical pattern as shown, such that the wheels of an upper cart deck 502 align with the orifices 706 of a lower cart deck 502 when the upper cart deck 502 is rotated 180 degrees with respect to the orientation of the lower cart deck 502.

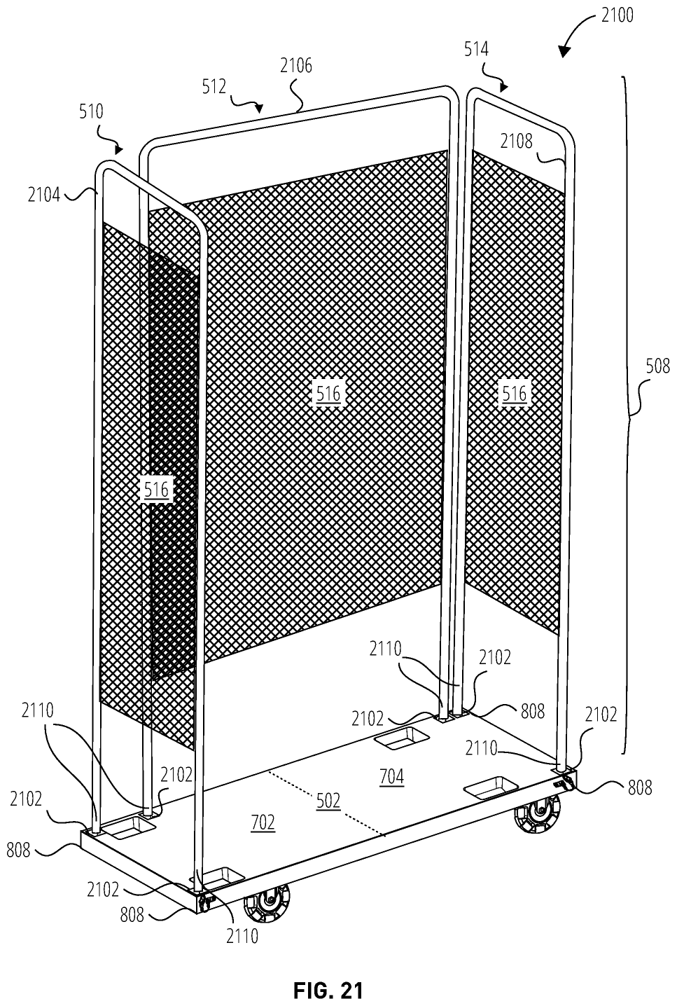

FIG. 19A-FIG. 19D illustrate cart decks engaged by conventional pallet jacks 1900 in accordance with one embodiment. FIG. 19A illustrates a bottom plan view, FIG. 19B and FIG. 19C illustrate isometric views, and FIG. 19D illustrates a front elevation view with multiple pallet jack sizes indicated.

Pallet jack forks may fit between the wheels 504 of a NUC 500 or cart deck 502 and be centered under the resulting load. Different forklift dimensions may be taken into account to calculate and design for accommodating a range of models. In some embodiments, the clearance between stacked cart decks may allow a pallet jack to insert between any two cart decks in the stack in order to lift one or more cart decks off the stack at one time.

FIG. 19C shows a pallet jack engaged with an assembled cart that is 24″ wide by 48″ long by 74″ total height. These dimensions may differ from one application to the next. The cart shown may use four omnidirectional wheels, such as double 125 mm diameter Rotacasters or other non-swivel, omnidirectional wheels for mobility. Such a cart may have a weight of 50 pounds, and may be picked up by a pallet jack or electric pallet jack.

As may be seen in FIG. 19D, the cart decks may be designed with wheel spacing 1902 that accommodates a range of pallet jack fork spacings, such as the pallet jack fork spacing 1904 and the pallet jack fork spacing 1906 shown. The pallet jack fork spacing may be measured at an axis of greatest fork width 1908 for the forks of the particular pallet jack.

FIG. 20 illustrates omnidirectional wheel movement degrees of freedom 2000 in accordance with one embodiment. The omnidirectional wheels 2002 may roll in an in-line movement 2004 as conventional wheels do, in a roll rotation around the wheel hub 2006. However, if in-line movement 2004 of the main omnidirectional wheel 2002 around the wheel hub 2006 is arrested, or movement of the cart perpendicular to the in-line movement 2004 is desired, the omnidirectional wheel 2002 may also be capable of side-to-side or transverse movement 2008, due to the pitch rotation of the small rollers 2010 around their roller pins 2012 along the perimeter of the wheel hub 2006.

Note that in some embodiments, the omnidirectional wheels 2002 used for the nested nesting utility carts disclosed herein may be prevented from moving in a swivel motion 2014 (yaw rotation) to improve case of stacking the disclosed nesting utility carts or cart decks, as well as security or stability of the stacks. The primary benefit of omnidirectional wheels 2002 may be their maneuverability in tight spaces, even when swivel motion 2014 is prevented.

FIG. 21 illustrates a NUC side wall tube frame configuration 2100 in accordance with one embodiment. The NUC side wall tube frame configuration 2100 may include a cart deck 502 and removeable side walls 508. The cart deck 502 may have a first portion 702, a second portion 704, corners 808, and tube orifices 2102. The removeable side walls 508 may include a first tube frame 510, a second tube frame 512, and a third tube frame 514.

In one embodiment, the NUC cart deck 502 may include four tube orifices 2102, each configured to receive one end 2110 of a first tube frame 510 or one end 2110 of a second tube frame 512. The cart deck 502 may have one tube orifice 2102 located at each of the four corners 808.

The first tube frame 510 may include a first tube 2104 with two ends 2110, with each end 2110 of the first tube 2104 located in separate tube orifices 2102 at the outer corners 808 in at least one of the first portion 702 of the cart deck 502 and the second portion 704 of the cart deck 502. The second tube frame 512 may include a second tube 2106 with two ends 2110, with each end 2110 of the second tube 2106 located in separate tube orifices 2102 at the outer corners 808 in at least one of the first portion 702 of the cart deck 502 and the second portion 704 of the cart deck 502. The removable side walls may include netting 516 netting attached in at least one of the following configurations: between the first tube frame 510 and the second tube frame 512, and on at least one of the first tube frame 510 and the second tube frame 512.

The nesting utility cart cart deck 502 may also include a tube orifice 2102 in the first portion 702 and a tube orifice 2102 in the second portion 704, each configured to receive one end 2110 of a third tube frame 514, the cart deck having one corner 808 in the first portion 702 with two tube orifices 2102 and one corner 808 in the second portion 704 with two tube orifices 2102. The third tube frame 514 may include a third tube 2108 with two ends 2110, with one end 2110 of the third tube 2108 located in one tube orifice 2102 at the first portion 702 corner 808 with two tube orifices 2102 and the second end 2110 of the third tube 2108 located in one tube orifice 2102 at the second portion 704 corner with two tube orifices 2102. Netting 516 may be attached between the first tube frame 510 and the second tube frame 512 and to at least a portion of the third tube frame 514. Other technical features may be readily apparent to one skilled in the art from the following figures, descriptions, and claims.

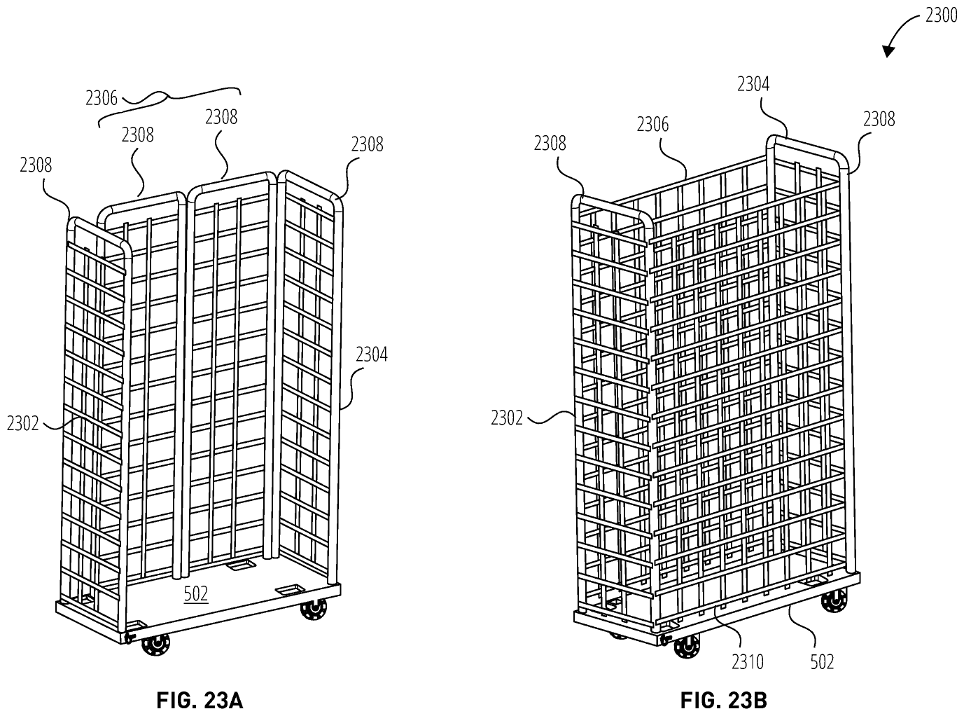

FIG. 22A-FIG. 22C illustrate a cart deck with locking pins 2200 in accordance with one embodiment. FIG. 22A shows an isometric view of four cart decks stacked. FIG. 22B shows a detail view of locking pin and wheel bracket securement. FIG. 22C shows in greater detail an inserted locking pin.

Side walls may be created by inserting tube frames, such as those introduced in FIG. 5A-FIG. 5F, into tube orifices accepting removable tube frame ends 2202. In one embodiment, the cart deck 502 may have tube orifices for a first tube frame forming a first side wall 2204, tube orifices for a second tube frame forming a second side wall 2206, tube orifices for a third tube frame forming a third side wall 2208, and tube orifices for third and fourth tube frames forming a third side wall 2210, as shown in FIG. 22A. Each tube orifice accepting a removable tube frame end 2202 may have a locking pin assembly 2212, as shown.

The locking pin assembly 2212, shown in detail in FIG. 22B, may include a spring loaded ball 2216, and, when removed, may be secured by a locking pin tether 2218 to the cart deck 502 to prevent the locking pin assembly 2212 from becoming separated from the cart deck 502 and lost. The locking pin assemblies 2212 may secure the tube frames 2214 into the orifices that accept them. As is also shown in FIG. 22B, metal brackets 2220 with plastic tapping screws 2222 may be used to secure the wheels 504 to the cart deck 502. These securements may also be plastic block to provide higher density. The cart deck 502 may be 20″ wide by 48″ long by 2″ thick.

Once a tube frame end 2224 is inserted in a tube orifice 2226, as shown in FIG. 22C, the locking pin 2228 of a locking pin assembly 2212 for that tube orifice 2226 may be inserted through an orifice pin hole 2230 for the tube orifice 2226. The locking pin 2228 may in this way engage with a frame pin hole 2232 in the tube frame end 2224. Locking pin assemblies 2212 securing the panels may be pulled from the orifice pin hole 2230 to free the tube frame end 2224 for removal. The tube frames may be thus removed and may be stacked separately. Tube frames may be placed on empty carts for storage or transport.

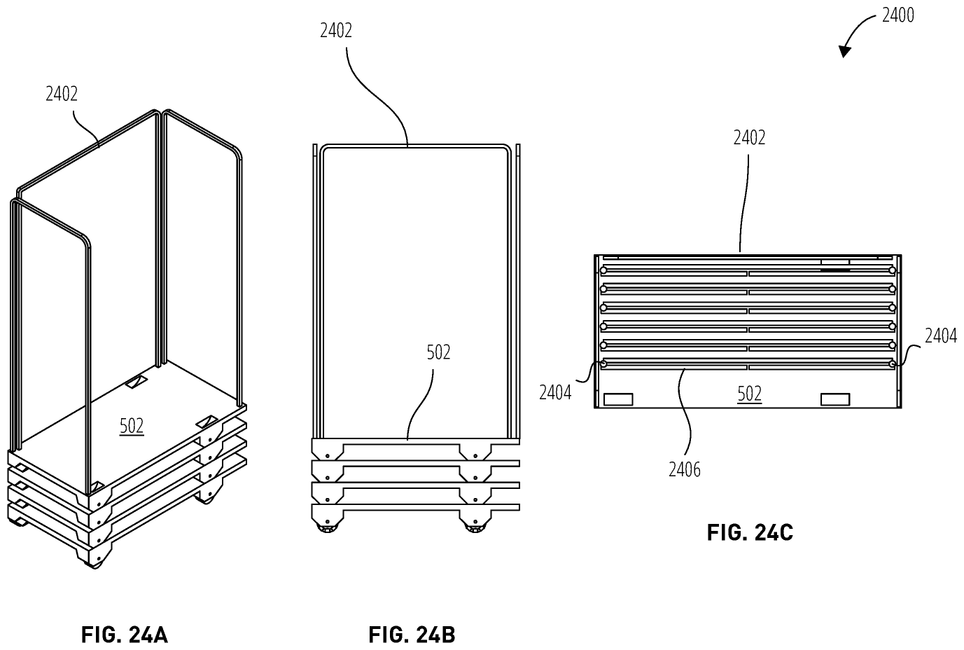

FIG. 23A and FIG. 23B illustrate nesting utility cart side wall configurations 2300 in accordance with one embodiment. FIG. 23B illustrates a nesting utility cart side wall configurations 2300 in accordance with one embodiment. The nesting utility cart may be of dimensions 20″ wide by 48″ long by 74″ tall.

The nesting utility cart may have four identical custom removable tube frames 2308, each retained with two tethered pins, as shown in FIG. 23A. A single removable tube frame 2308 with cargo webbing may form the side walls for each of a first side wall 2302 and a second side wall 2304, and retaining pins may secure the removable tube frames 2308 to the cart deck 502. A sidewall for a third side wall 2306 may comprise two removable tube frames 2308, each of which may be spanned by its own cargo webbing in one configuration, or both of which together may be spanned by a single, larger piece of cargo webbing.

In another embodiment, as shown in FIG. 23B, the nesting utility cart may have two removable tube frames 2308, one each for a first side wall 2302 and a second side wall 2304. Netting 516 may be used across both tube frames, as well as across both sides of the gap between the first side wall 2302 and second side wall 2304, to form the third side wall 2306 and a fourth side wall 2310, as shown. Each design may have a 2″ thick plastic cart deck 502, which may be machined, injection molded, or formed by some other process as will be understood by one of skill in the art. Other designs may be easily envisioned by one of skill in the art.

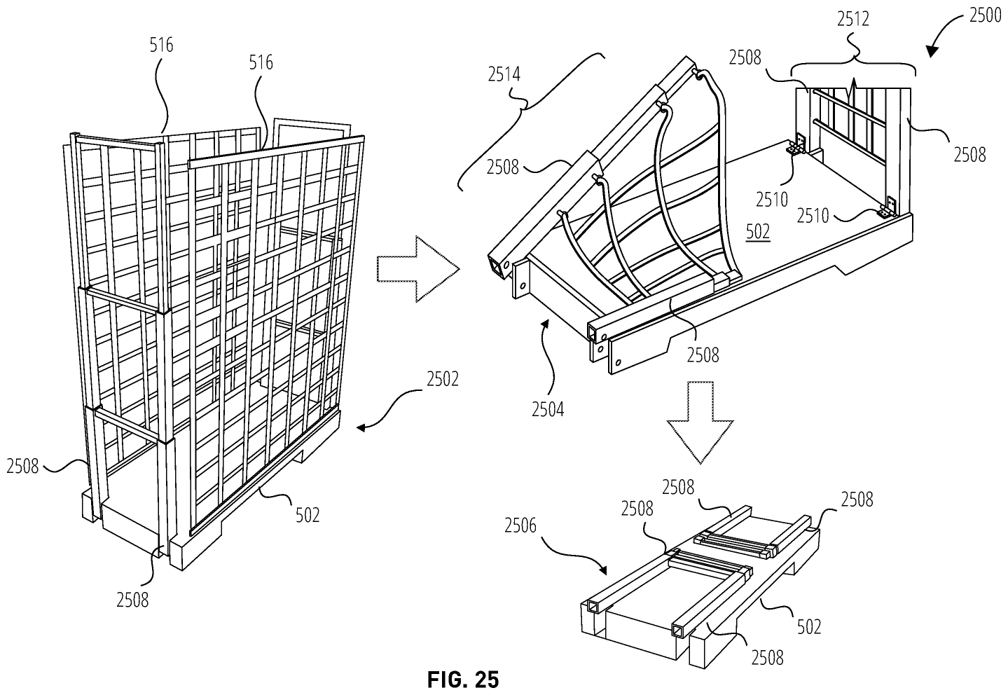

FIG. 24A-FIG. 24C illustrate a nesting utility cart with folding tube frame side walls 2400 in accordance with one embodiment. FIG. 24A shows an isometric view of a cart stack, FIG. 24B slows a left elevation view of the cart stack, and FIG. 24C shows a top plan view of the cart stack with additional tubing frames held for storage or transport. The nesting design may allow for stackability.

The side walls may be designed with folding tube frame assemblies 2402 able to be folded at folding joints 2404 as shown in FIG. 24C. In this manner, with one folding tube frame assembly 2402 installed in the top cart deck of the stack, that top cart may accommodate folding tube frames held for storage or transport 2406 as shown. In one embodiment, staked pockets may be used to secure the side walls to the cart deck. In one configuration of such an embodiment, one long and two short sidewalls may be used, with netting removably configured across open sides to facilitate loading and secure cases loaded onto the NUC.

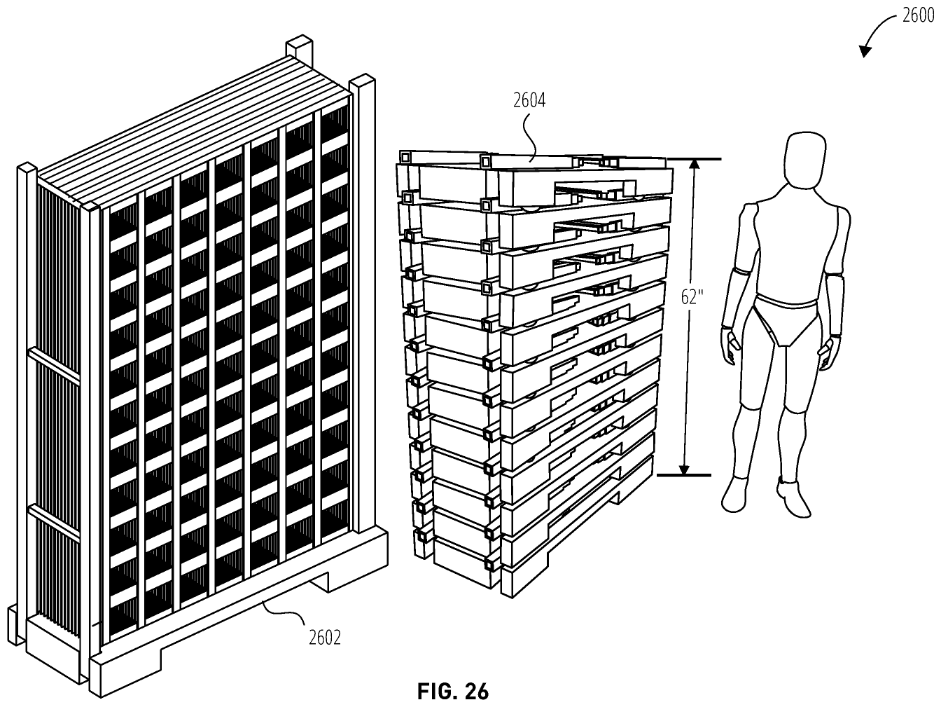

FIG. 25 illustrates a nesting utility cart with collapsible side walls 2500 in accordance with one embodiment. The nesting utility cart with collapsible side walls 2500 may comprise a cart deck 502 and netting 516 spanning four retracting poles 2508 attached to the cart deck 502 by four collapsible brackets 2510. Retracting poles 2508 and collapsible brackets 2510 may allow for fixed and hinged operation. The nesting utility cart with collapsible side walls 2500 may use collapsible brackets 2510 and retracting poles 2508 with various locking mechanisms to maintain each in state to form an uncollapsed cart 2502, as will be familiar to those of ordinary skill in the art.

These locking mechanisms may be disengaged to allow retracting poles 2508 to collapse and retract as shown by the partially collapsed side wall 2514 of the partially collapsed cart 2504 illustrated herein. Each sidewall may be independently collapsible in one embodiment, as shown with the secured upright and expanded side wall 2512 and partially collapsed side wall 2514 illustrated for the partially collapsed cart 2504. An uncollapsed cart 2502 may have its netting removed, and its side walls may be collapsed fully, rendering it a fully collapsed cart 2506 as shown.

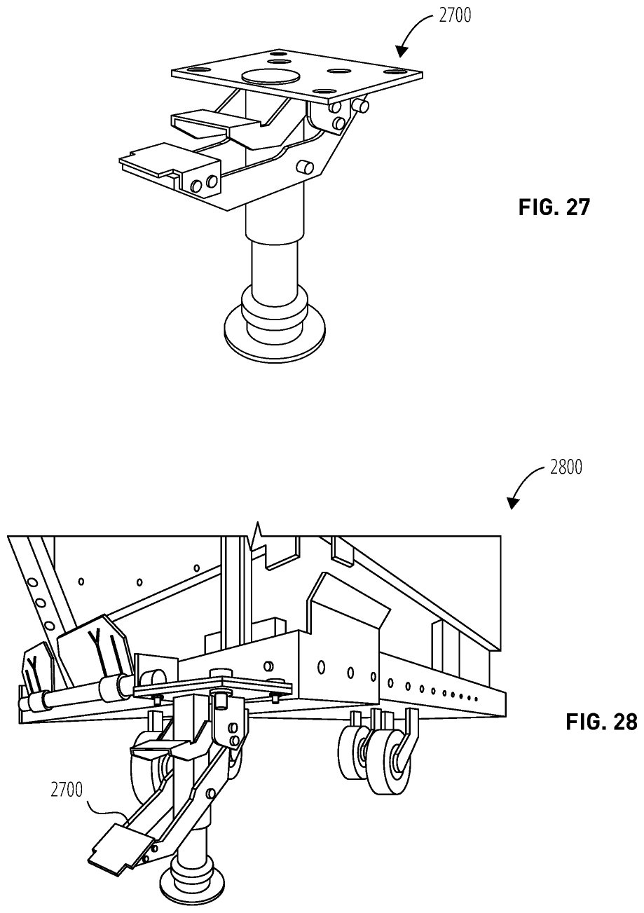

FIG. 26 illustrates nesting utility carts with collapsible side walls configured for storage or stacked transport 2600 in accordance with one embodiment. This collapsible concept may be combined with an automatic stacker (stack dispenser). An uncollapsed cart holding netting from collapsed carts for storage or transport 2602 may be used. Twelve fully collapsed carts stacked for storage or transport 2604 may be 62″ tall in one embodiment.

FIG. 27 illustrates a locking floor brake 2700. The locking floor brake 2700 may apply a locking force against the floor, preventing motion of the disclosed NUC as a whole, independent from cessation of motion of the wheels. The locking floor brake 2700 may not lift the NUC but may apply a preloading force using a spring. In one embodiment, one locking floor brake 2700 may be used. In another embodiment, two may be used, one for each short side of the cart deck.

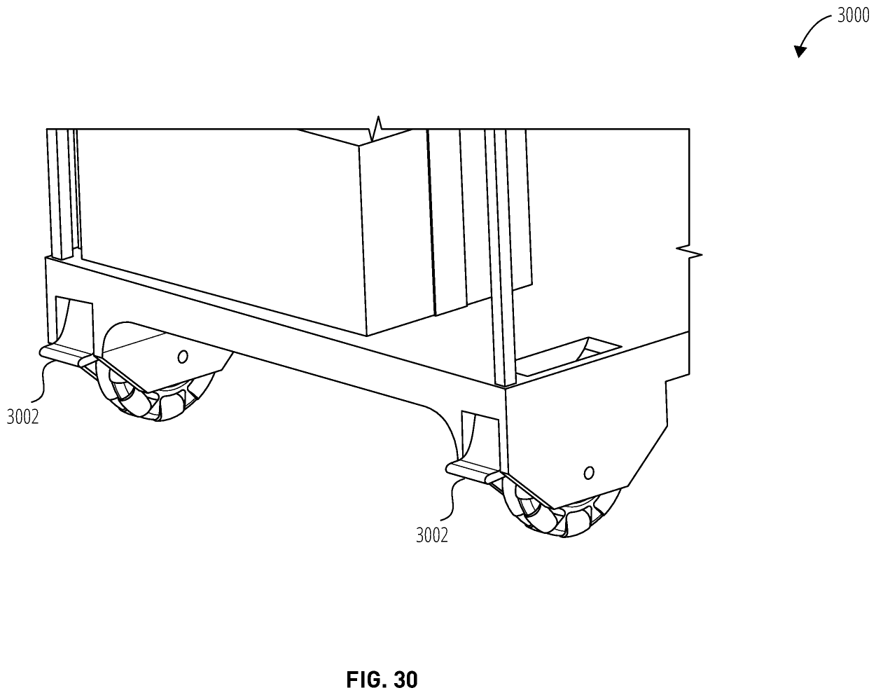

FIG. 28 illustrates a floor brake locking mechanism configuration 2800 using the locking floor brake 2700.

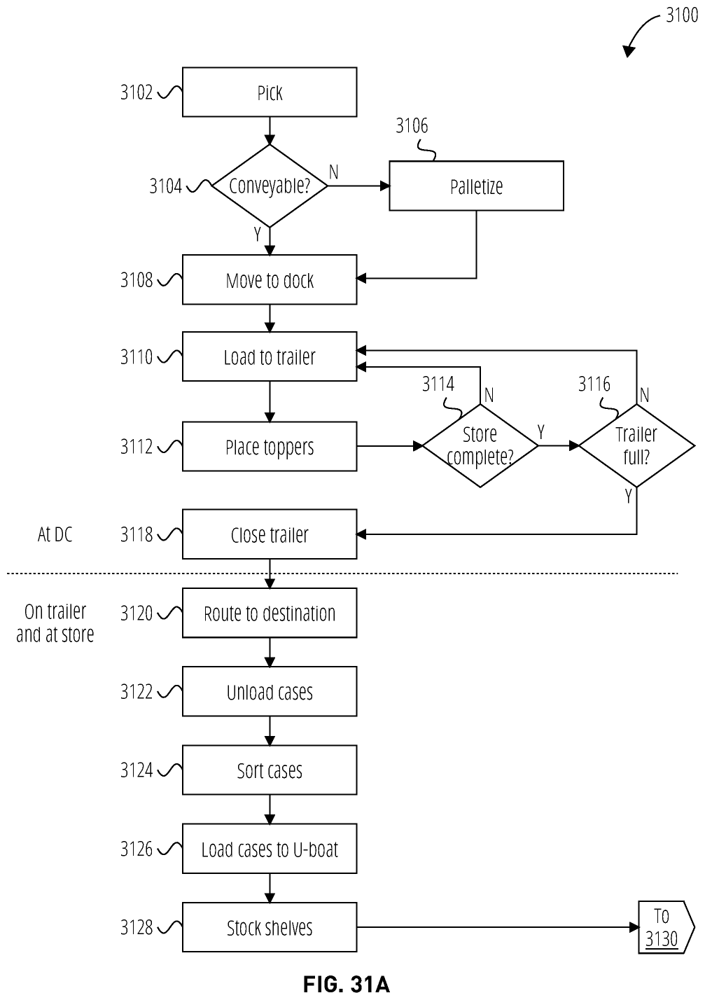

FIG. 29 illustrates a dual wheel foot brake locking mechanism configuration 2900. The dual wheel foot brake locking mechanism configuration 2900 applies locking pressure onto two wheels at the same time. The dual wheel foot brake locking mechanism configuration 2900 may be molded into the disclosed cart deck in one embodiment to provide dual locking on the wheels. The dual wheel foot brake locking mechanism configuration 2900 may be modified in one embodiment to prevent both in-line and transverse movement.

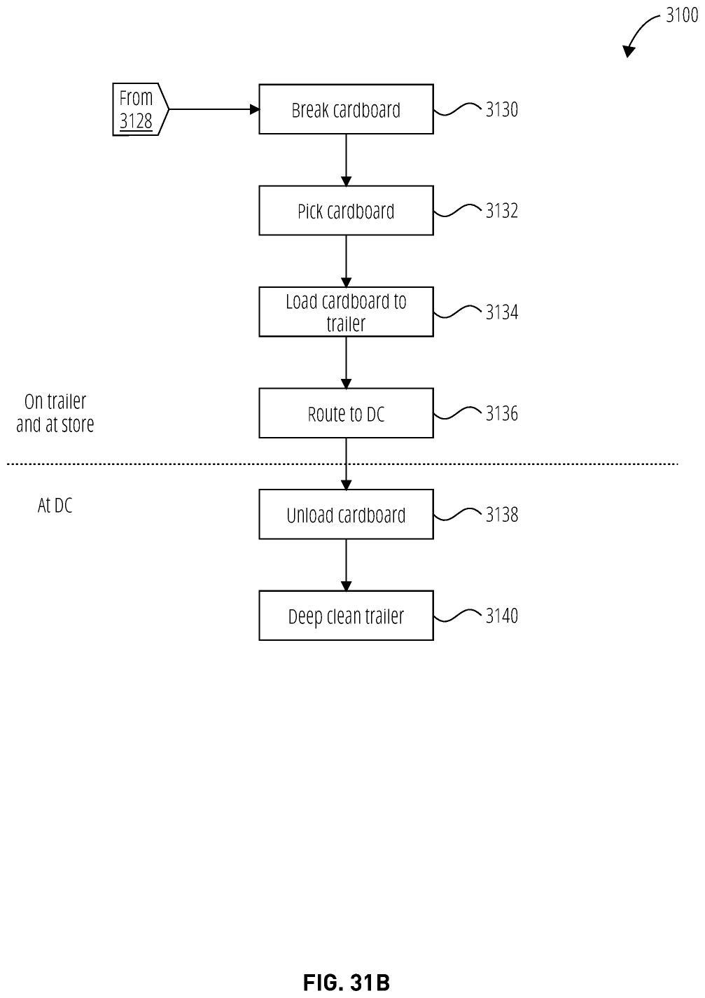

FIG. 30 illustrates an individual wheel locking mechanism configuration for omnidirectional wheels 3000 in accordance with one embodiment. Wheel locking mechanisms 3002 may be molded into the base of one or more wheels to provide locking on each omnidirectional wheel, individually. Such locks may prevent in-line movement but may not stop transverse movement. Additional modifications may be made to prevent transverse movement of the nesting utility cart.

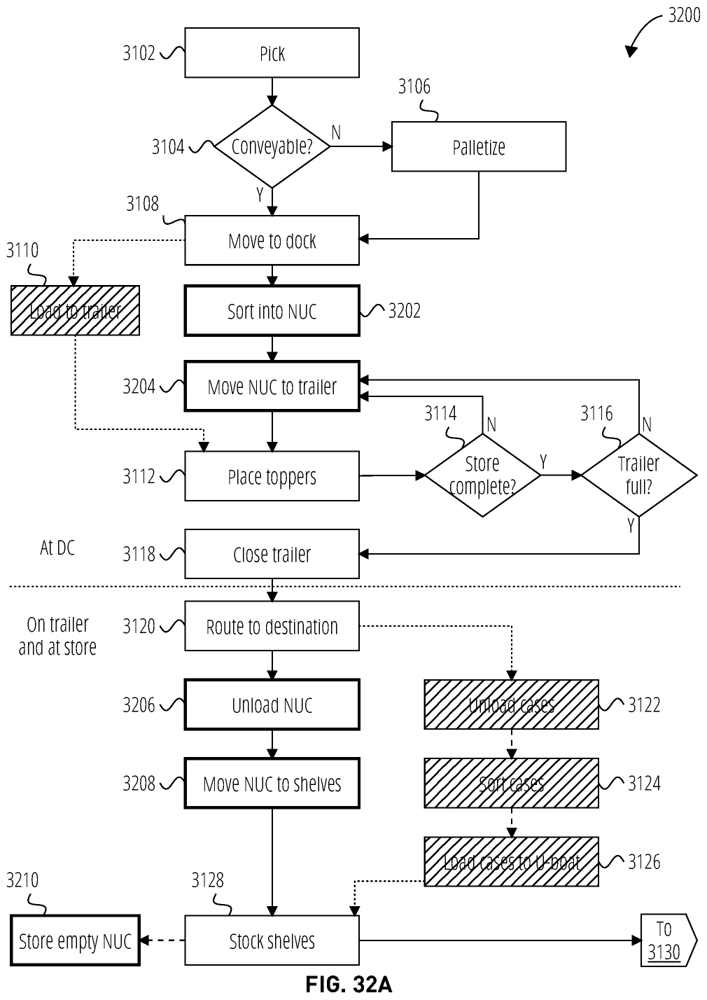

FIG. 31A and FIG. 31B illustrate a conventional delivery routine 3100 in accordance with one embodiment. The conventional delivery routine 3100 may begin at block 3102 with items intended for shipment being picked from storage at a distribution center. The items may be packaged in cardboard cases, palletized, or otherwise suitably contained. If the items are packaged in a manner not suitable for shipping or for conveyance via conveyor belts, including extendable conveyor belts, as determined at decision block 3104, the items may be palletized for conveyance and shipping at block 3106.

Once the items are packaged suitably for conveyance and shipping, they may be moved to the shipping dock at block 3108. They may then be loaded onto the trailer or shipping truck container at block 3110 and toppers may be placed on top of grouped stacks of items at block 3112. If a complete shipment intended for a particular destination has not yet been loaded at decision block 3114, loading may continue, the conventional delivery routine 3100 returning to block 3110. If the destination's order is completely loaded at decision block 3114, it may be determined at decision block 3116 if the trailer or container is full. If the trailer is not full at decision block 3116, loading may continue with shipments intended for other locations, the conventional delivery routine 3100 returning to conventional delivery routine 3100. If the trailer is full at decision block 3116, the trailer may be closed at block 3118.

At block 3120, the trailer or container may be routed to a destination where items are to be delivered. Upon arrival, at block 3122, the items, cases, and/or pallets intended for that destination may be unloaded at block 3122 and sorted or segregated at block 3124 into groups by category to facilitate efficient distribution at the destination. At block 3126 the items, cases, and/or pallets may be loaded onto U-boats or other modes of transport throughout the destination facility. Shelves or other storage areas may be stocked with the items at block 3128.

At block 3130 cardboard cases may be broken down for more efficient storage or return shipment. Where cardboard is to be returned to the distribution center, the carboard may be picked at block 3132 and loaded back onto the trailer at block 3134. The trailer may continue until it has made deliveries at all intended destinations and may then route back to the distribution center at block 3136. At the distribution center, any cardboard sent back from the destination(s) may be unloaded at block 3138. Finally, at block 3140, the trailer or container may be deep cleaned.

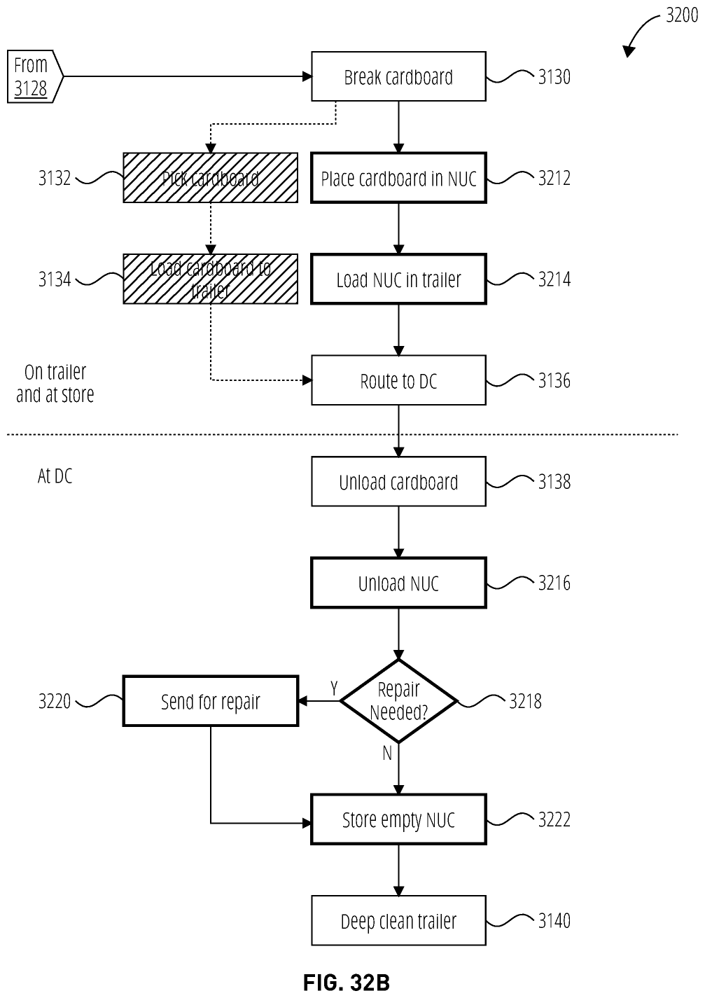

FIG. 32A and FIG. 32B illustrate a NUC delivery routine 3200 in accordance with one embodiment. Many of the steps of conventional delivery routine 3100 as described above remain applicable in the NUC delivery routine 3200, and those steps are represented in the NUC delivery routine 3200, though they may not be redescribed in detail. Where steps from the conventional delivery routine 3100 may be omitted when following the NUC delivery routine 3200, those steps are shown with a hash pattern. Where steps pertain only to the NUC delivery routine 3200, they are shown bordered with heavier line weights.

The NUC delivery routine 3200 may begin at the distribution center with similar steps to the conventional delivery routine 3100. Once moved to the shipping dock at block 3108, items, cases, and/or pallets may be sorted onto NUCs by destination at block 3202. If grouping categories pertinent to the destination are known, the items may be sorted onto NUCs by these categories as well. The NUCs may then be moved onto the trailer at block 3204 with toppers placed at block 3112, until the trailer is full, as previously described.

At the destination, the NUCs for that destination may be unloaded at block 3206. The cases no longer need to be unloaded, sorted, and reloaded, but the pre-sorted NUC loads may be moved directly to the shelves or other storage areas at block 3208 to facilitate stocking. Once the items are stored at the destination and the NUCs are empty, they may in some cases be stored at the destination facility at block 3210. Otherwise, any cardboard for return to the distribution center may be placed in the NUCs at block 3212 and the NUCs may be loaded back onto the trailer at block 3214.

Once back at the distribution center, the empty NUCs may be unloaded at block 3216. If it is determined that any NUCs repair at decision block 3218, they may be sent to a repair station or shop for that repair at block 3220. Empty NUCs in good repair may be stored in the distribution center for future use at block 3222.

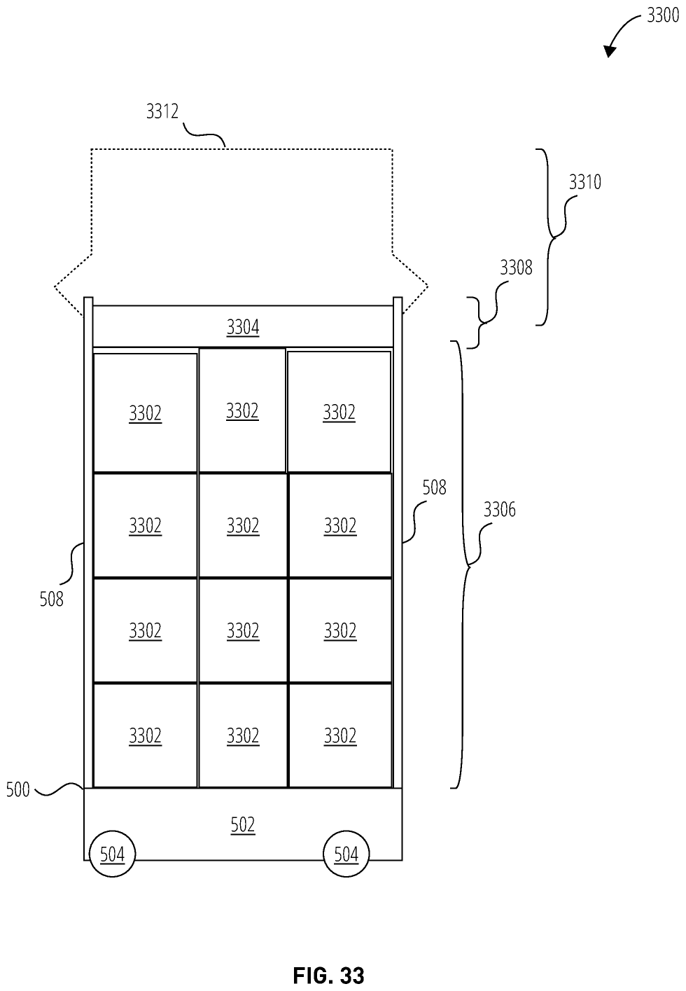

FIG. 33 illustrates recommended NUC loading heights 3300 in accordance with one embodiment. A NUC 500 is shown having a cart deck 502, wheels 504, and removeable side walls 508. The NUC 500 is loaded with exemplary shipping cases 3302 and topper 3304. Starting at the floor formed by the cart deck 502, a recommended case loading height 3306 extends to nearly the top of the removeable side walls 508. If a topper 3304 is desired, loading for the shipping cases 3302 may be confined to the cart volume below the maximum point in the range of the recommended case loading height 3306.

The topper 3304 may be loaded within the range of the recommended topper loading height 3308. If a topper 3304 is not needed, the shipping cases 3302 may be loaded up to the maximum point in the range of the recommended topper loading height 3308. Above this, there is a height at which topper and case loading is not recommended 3310 unless the shipping cases 3302 and/or toppers 3304 loaded at this height are otherwise secured, such as by being strapped to the cases below, as shipping cases 3302 or toppers 3304 loaded beginning in this range may have a center of gravity be above the cart side walls and may thus be unstable.

Exemplary values for the recommended case loading height 3306, recommended topper loading height 3308, and height at which topper and case loading is not recommended 3310 for a cart having an exemplary height of 74″ are 70″, 72″, and above 72″, respectively. However, the absolute maximum loading height 3312 may be dictated by the height of the trailer or shipping container, which is typically 109″ to 114″.

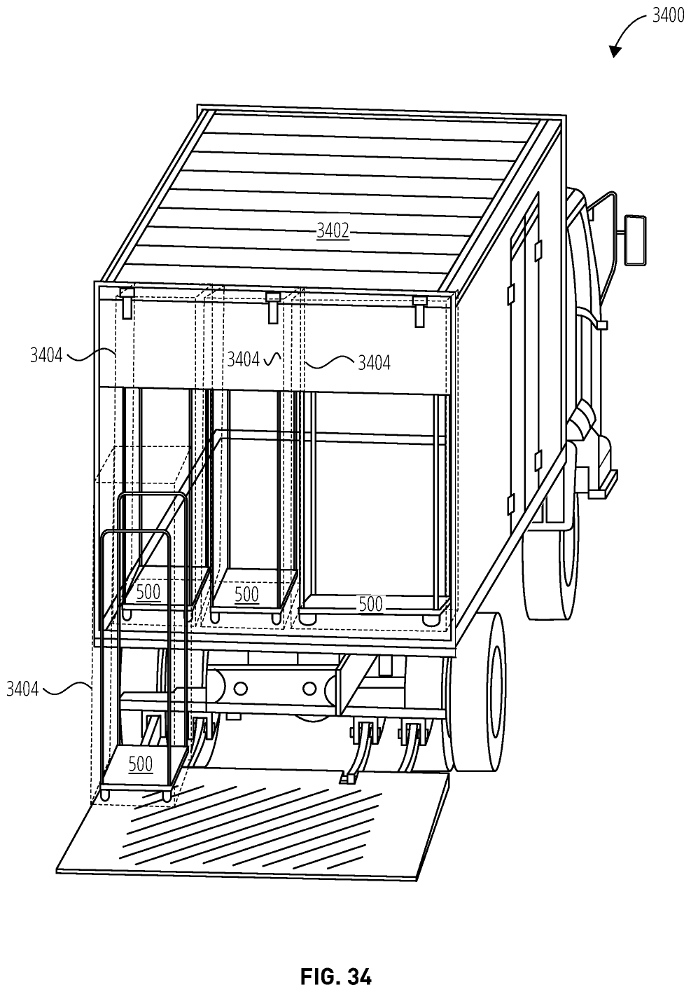

FIG. 34 illustrates NUC spacing and arrangement in a truck container 3400 in accordance with one embodiment. A typical truck container 3402 may be 96″ tall, 48′-53′ long, and 101″ wide. NUCs 500 may be designed to have dimensions such that a certain number of cart footprints are available, with appropriate clearances, so that a specific number of loaded carts or stacked empty carts may be fit securely and optimally within a truck container 3402. For example, the nesting utility cart footprint and clearances 3404 may allow carts to be loaded four across when aligned with their narrow dimensions toward the door, or two across with their wide dimensions toward the door, as may be seen for the NUCs 500 illustrated in this figure.

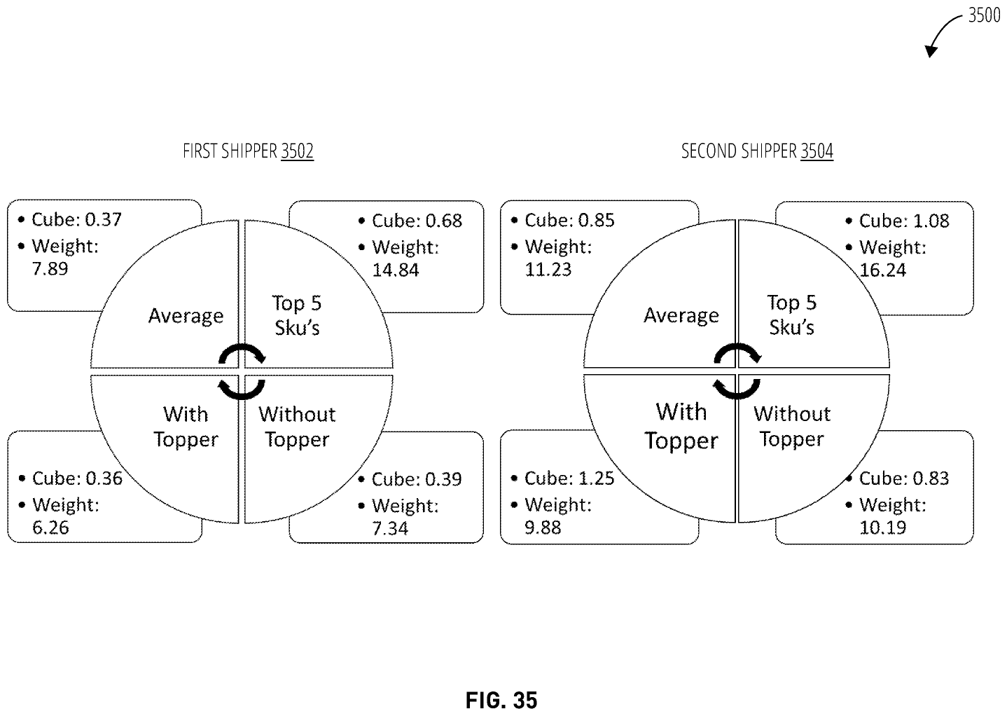

FIG. 35 illustrates typical case sizes for two exemplary shippers 3500. Volume dimensions (shown as “Cube”) are measured in cubic feet. Case size data such as this may be used to analyze which cart deck and side wall dimensions may best accommodate a typical load for a particular shipper. For first shipper 3502, a topper may include paper products, stationery, toys, crafts, promotional items, seasonal items, and candy. For second shipper 3504, a toper may be identified based on a stack code. For example, stack code “0” pertaining to a product category of “Other/Seasonal” may be defined as a topper. A topper may constitute 25% of total stock keeping units (SKUs) for first shipper 3502 and 30% for second shipper 3504.

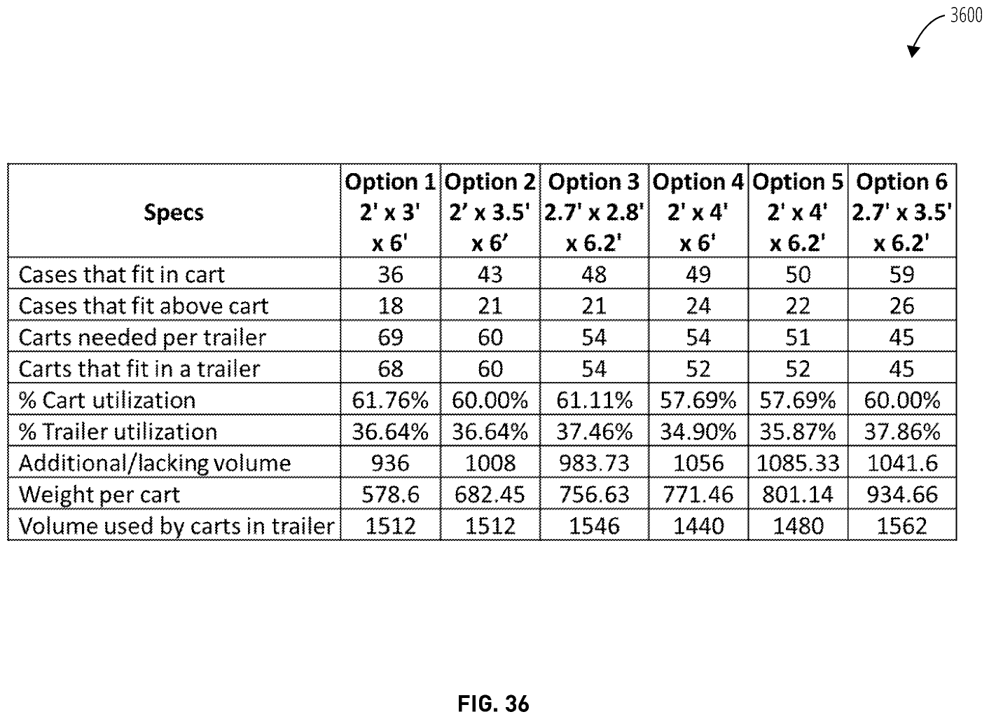

FIG. 36 illustrates a cart analysis worst case for first shipper 3600 in accordance with one embodiment.

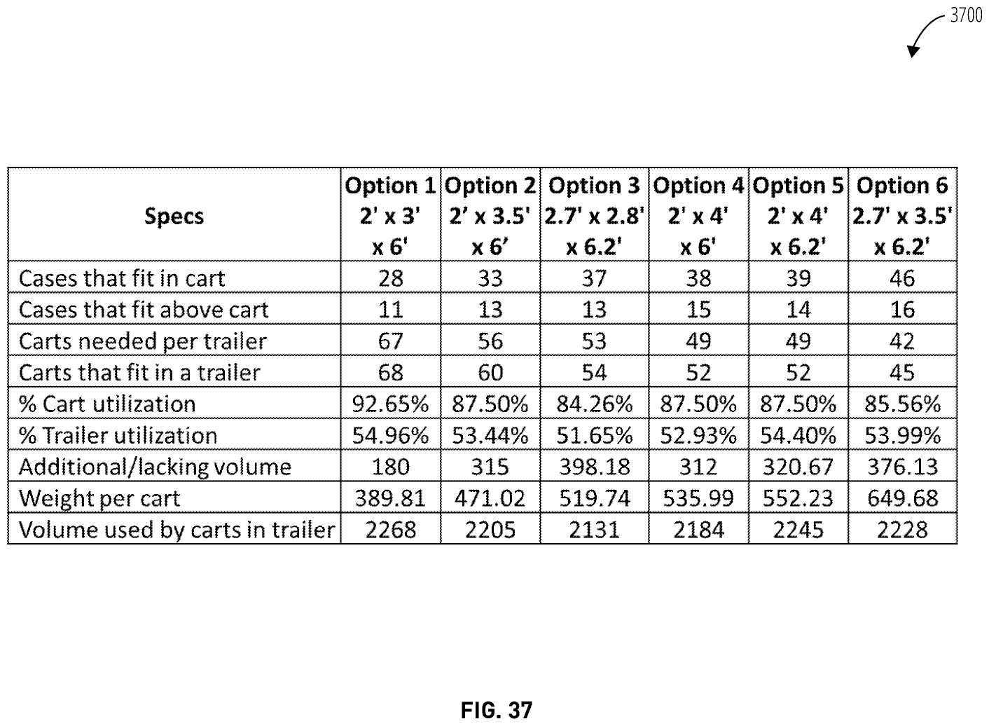

FIG. 37 illustrates a cart analysis best case for second shipper 3700 in accordance with one embodiment.

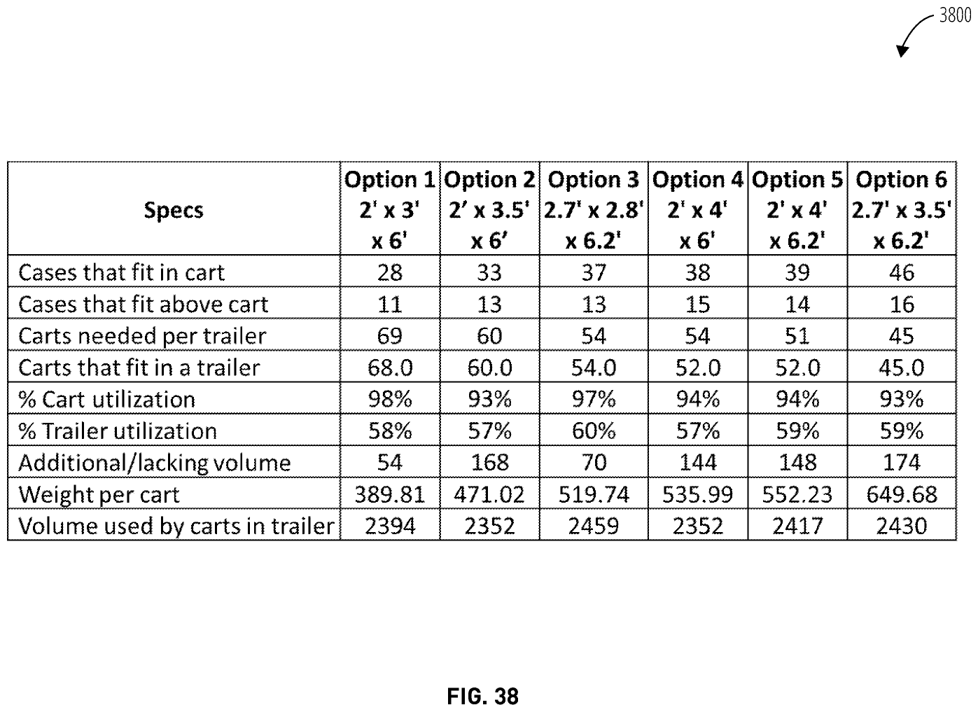

FIG. 38 illustrates a cart analysis average case for second shipper 3800 in accordance with one embodiment.

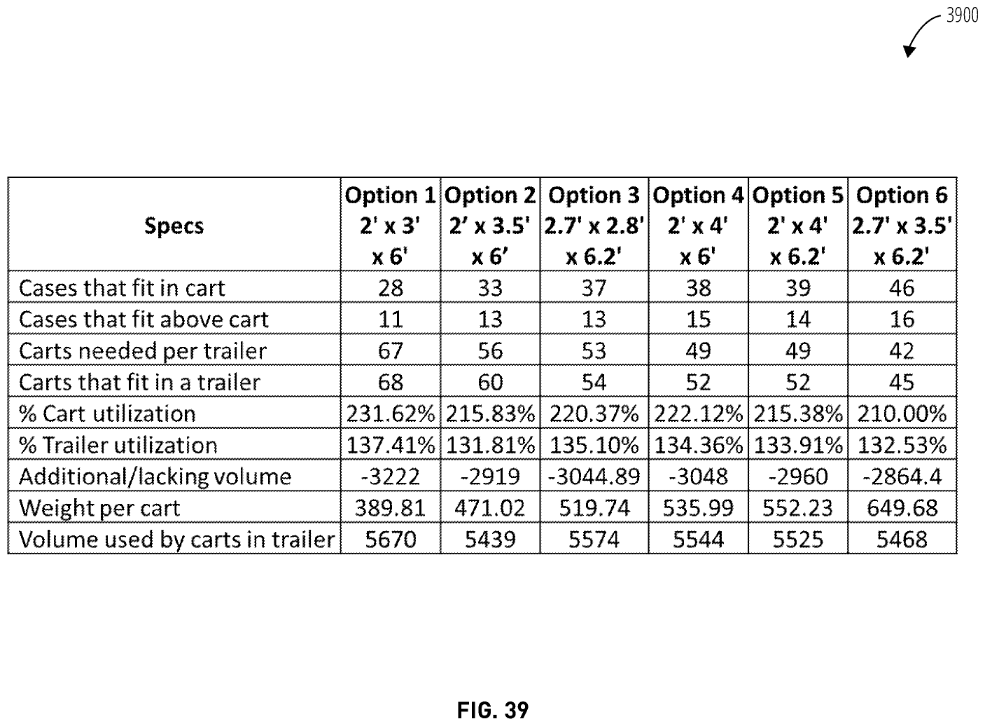

FIG. 39 illustrates a cart analysis worst case for second shipper 3900 in accordance with one embodiment.

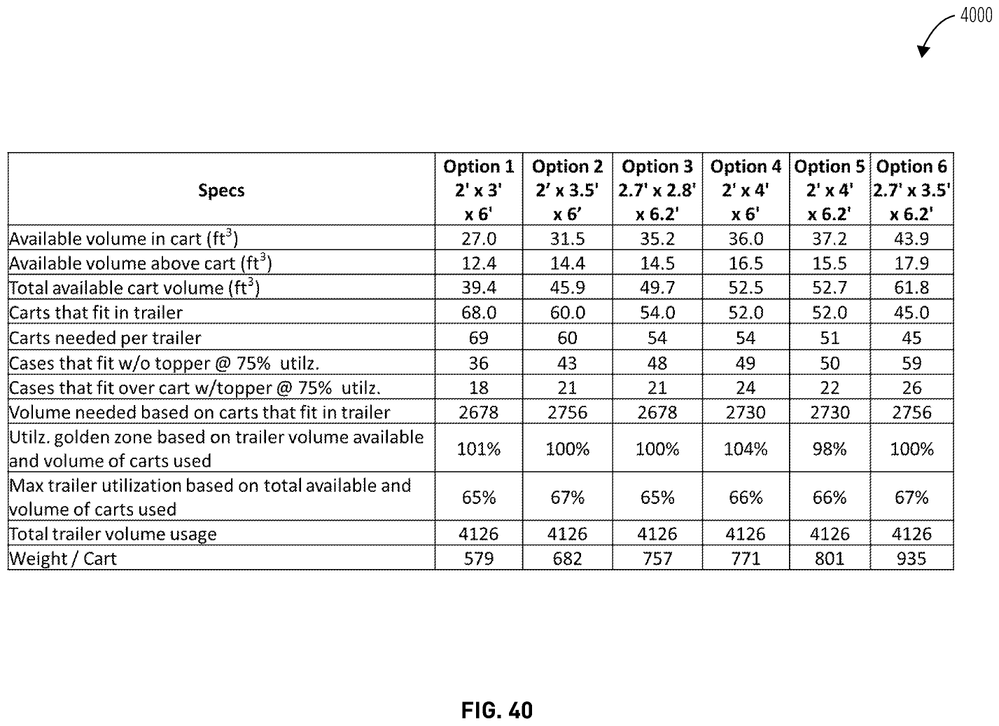

FIG. 40 illustrates a space analysis scenario for the first shipper 4000 in accordance with one embodiment. This space analysis scenario for the first shipper 4000 is performed for first shipper 3502 introduced in FIG. 35. The space analysis scenario for the first shipper 4000 assumes that a trailer needs to load shipments for three stores, each store having a shipment of 1,187 cases loaded on NUCs using toppers. Six options for NUC dimensions are examined. Where a cart is mentioned in the table, it is intended that the cart be a NUC. “Golden zone” refers to a zone that is optimized based on an ergonomic assessment of the available space.

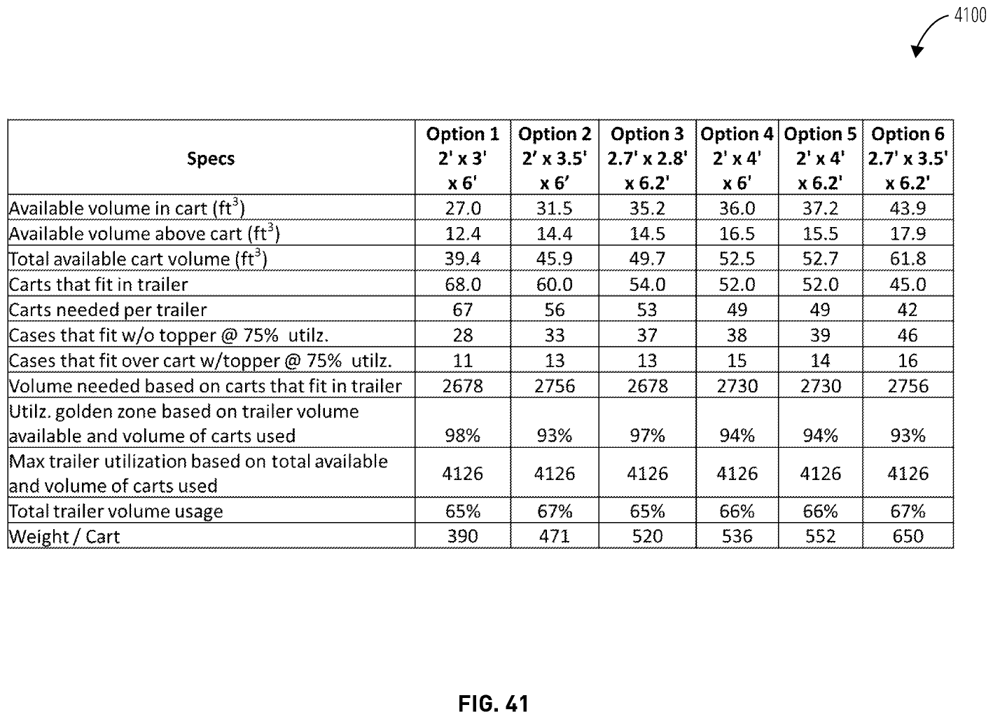

FIG. 41 illustrates a space analysis scenario for the second shipper 4100 in accordance with one embodiment. The space analysis scenario for the second shipper 4100 is performed for second shipper 3504 introduced in FIG. 35. The space analysis scenario for the second shipper 4100 assumes that a trailer needs to load shipments for 3.5 stores, each store having a shipment of 757 cases loaded on NUCs using toppers. Six options for NUC dimensions are examined. Where a cart is mentioned in the table, it is intended that the cart be a NUC.

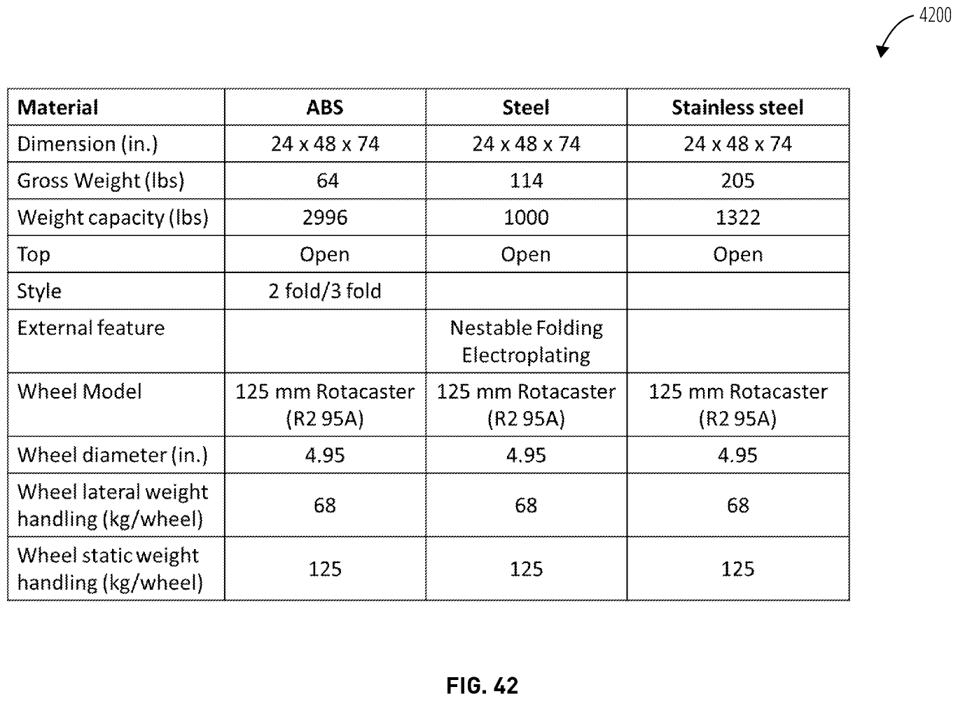

FIG. 42 illustrates exemplary material specifications 4200 in accordance with one embodiment. Information is provided for NUCs having dimensions of 24″ wide, 48″ long, and 72″ tall, with cart decks made from acrylonitrile butadiene styrene (ABS), steel, or stainless steel, and using, for exemplary purposes, Rotacastor R2 95A wheels.

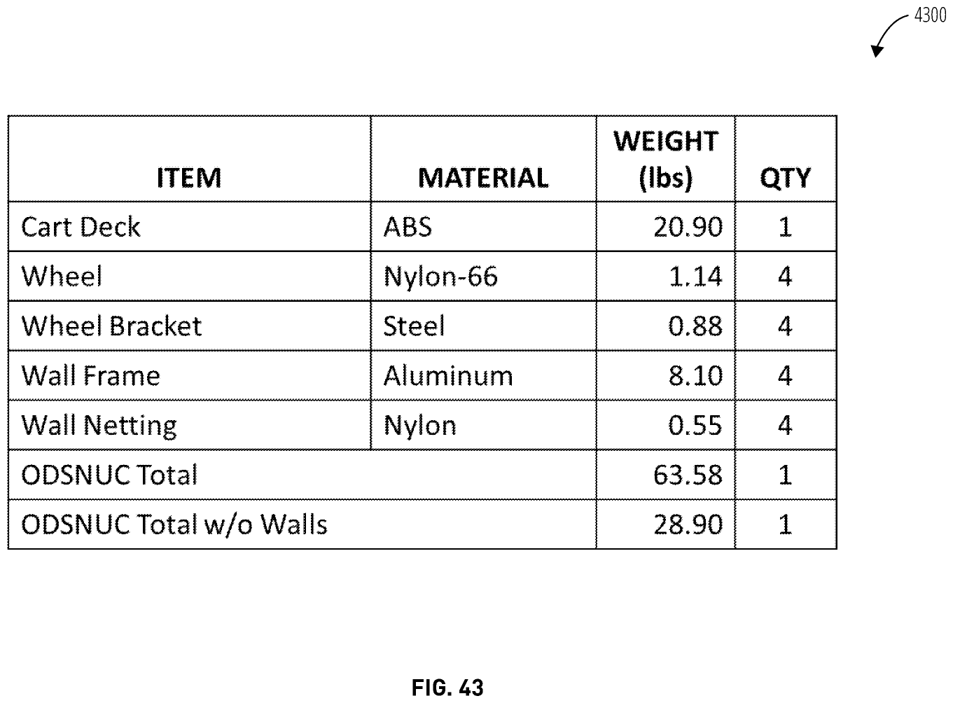

FIG. 43 illustrates weight estimates for a NUC with removable side walls 4300 in accordance with one embodiment. This exemplary cart uses a cart deck made from ABS.

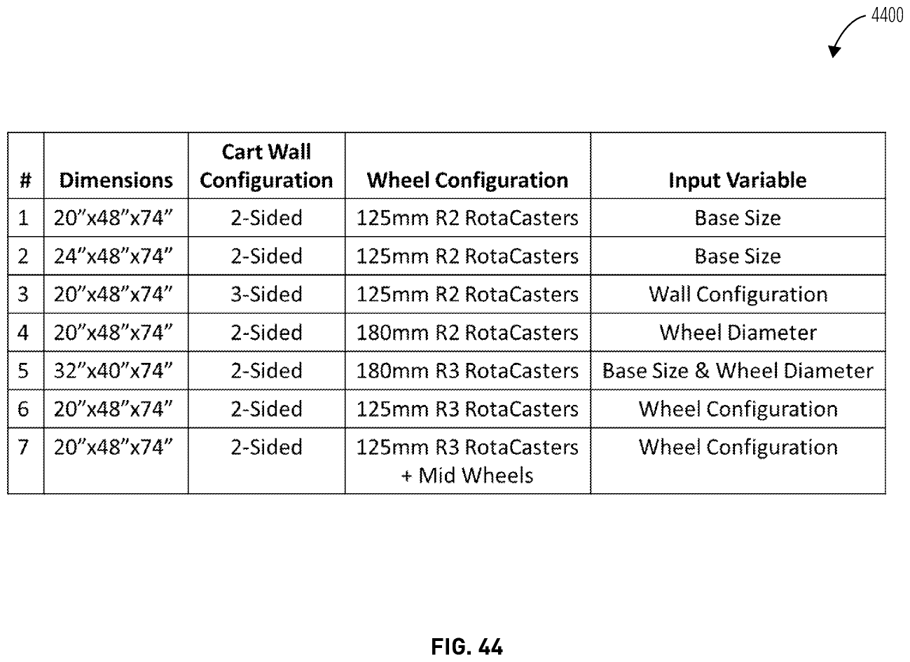

FIG. 44 illustrates exemplary NUC variants 4400 in accordance with one embodiment. All of these may be adaptable to use without wheels as static pallets.

FIG. 45 illustrates exemplary worker health and safety data 4500 in accordance with one embodiment. The Occupational Safety and Health Administration (OSHA) limits for a task lasting more than 5 seconds is 50 pounds, as is shown by table 4502. The upper force limits shown are for a horizontal pushing or pulling activity performed while standing. This equates to a loaded cart weight of approximately 1,200 pounds.

Standard posture ability is 66 pounds for a male human and 48 pounds for a female human, as indicated by table 4504. This data assumes a pushing forward movement measured in pounds against a round knob that is 50 mm in diameter. The knob is presented at various heights, and is assumed to be pushed with a preferred hand. Free posture is unrestricted. Standard posture has one foot 30 cm in front of the other and elbow at 90 degrees of flexion.

In order to determine the stress on a vertical frame of a NUC, the force of a human push was investigated using a variety of loads on a manual pallet jack. The results are shown in table 4506. It is anticipated that the disclosed cart may be easier to move than a manual pallet jack.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure may be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed field programmable gate array (FPGA), for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” may be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

While this disclosure has been described with reference to illustrative embodiments, this description is not intended to be construed in a limiting sense. Various modifications and combinations of the illustrative embodiments as well as other embodiments of the disclosure will be apparent to persons skilled in the art upon reference to the description. The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A nesting utility cart comprising:
a cart deck having a first portion and a second portion;
at least two wheels each secured to opposing sides of the first portion of the cart deck, and at least two wheels each secured to opposing sides of the second portion of the cart deck;
at least two orifices each through opposing sides of the first portion of the cart deck, and at least two orifices each through opposing sides of the second portion of the cart deck;
wherein the orifices are dimensioned to accept at least a portion of similar wheels of an overlaying similar cart deck;
wherein the at least two orifices in the first portion of the cart deck and the at least two orifices in the second portion of the cart deck are in a position to receive the similar wheels of the overlaying similar cart deck;
wherein the overlaying similar cart deck is nested in a reverse manner with respect to the first portion and second portion of the cart deck;
wherein the similar wheels of the over laying similar cart deck nest within the at least two orifices in the first portion of the cart deck and the at least two orifices in the second portion of the cart deck; and
wherein each similar wheel protrudes below a bottom surface of the cart deck.

2. The nesting utility cart of claim 1, wherein the wheels are omnidirectional wheels.

3. The nesting utility cart of claim 1,
the first portion including:
two first portion nesting assemblies, each first portion nesting assembly including one wheel adjacent to one orifice; and
the second portion including:
two second portion nesting assemblies, each second portion nesting assembly including one wheel adjacent to one orifice.

4. The nesting utility cart of claim 3, further comprising a centralized nesting assembly including: one centralized wheel adjacent to a centralized orifice, wherein at least one of:
the centralized wheel is located in at least one of the first portion and second portion; and
the centralized orifice is located in at least one of the first portion and the second portion.

5. The nesting utility cart of claim 4, wherein the centralized wheel is located in the first portion and the centralized orifice is located in the second portion.

6. The nesting utility cart of claim 3, further comprising:
a first additional nesting assembly; and
a second additional nesting assembly;
wherein each first and second additional nesting assembly includes one wheel adjacent to one orifice;
wherein at least one of the wheel and the orifice of the first additional nesting assembly is located in the first portion and at least one of the wheel and the orifice of the first additional nesting assembly is located in the second portion; and
wherein at least one of the wheel and the orifice of the second additional nesting assembly is located in the first portion and at least one of the wheel and the orifice of the second additional nesting assembly is located in the second portion.

7. The nesting utility cart of claim 3, wherein the wheels in the two first portion nesting assemblies are displaced from each other a greater distance than the wheels of the two second portion nesting assemblies are displaced from each other.

8. The nesting utility cart of claim 3,
wherein the cart deck comprises two corners in the first portion and two corners in the second portion; and
wherein each first portion nesting assembly and each second portion nesting assembly is located in close proximity to a separate corner.

9. The nesting utility cart of claim 3,
wherein the cart deck comprises a first side, a second side, a third side and a fourth side,
wherein the first side is in the first portion, the second side is in the first portion and the second portion, the third side is in the second portion, and the fourth side is in the first portion and the second portion;
wherein each first portion nesting assembly is configured with the first portion nesting assembly orifice closer to the first side than the first portion nesting assembly wheel, and
each second portion nesting assembly is configured with the second portion nesting assembly wheel closer to the third side than the second portion nesting assembly orifice.

10. The nesting utility cart of claim 9,
wherein both of the first portion nesting assemblies have the same of at least one of the following configurations:
both the first portion nesting assembly wheel and the first portion nesting assembly orifice are substantially equidistant from the second side or the fourth side; and
both the first portion nesting assembly wheel and the first portion nesting assembly orifice are not equidistant from the second side or the fourth side;
wherein both of the second portion nesting assemblies have the same of at least one of the following configurations:
both the second portion nesting assembly wheel and the second portion nesting assembly orifice are substantially equidistant from the second side or the fourth side; and
both the second portion nesting assembly wheel and the second portion nesting assembly orifice are not equidistant from the second side or the fourth side.

11. The nesting utility cart of claim 1, further comprising:
four tube orifices, each configured to receive one end of a first tube frame or one end of a second tube frame, the cart deck including four corners and having one tube orifice located at each corner;
removable side walls including:
the first tube frame comprising a first tube with two ends, with each end of the first tube located in separate tube orifices at the outer corners in at least one of:
the first portion of the cart deck; and
the second portion of the cart deck;
the second tube frame comprising a second tube with two ends, with each end of the second tube located in separate tube orifices at the outer corners in at least one of:
the first portion of the cart deck; and
the second portion of the cart deck;
netting attached in at least one of the following configurations:
between the first tube frame and the second tube frame; and
on at least one of the first tube frame and the second tube frame.

12. The nesting utility cart of claim 11, further comprising:
a tube orifice in the first portion and a tube orifice in the second portion, each configured to receive one end of a third tube frame; the cart deck having one corner in the first portion with two tube orifices and one corner in the second portion with two tube orifices;
the third tube frame comprising a third tube with two ends, with one end of the third tube located in one tube orifice at the first portion corner with two tube orifices and the second end of the third tube located in one tube orifice at the second portion corner with two tube orifices; and
the netting attached between the first tube frame and the second tube frame and to at least a portion of the third tube frame.

13. The nesting utility cart of claim 11, further comprising:
a frame pin hole in each end of the first tube frame and each end of the second tube frame, the frame pin hole configured to receive a locking pin, wherein the locking pin is removable;
an orifice pin hole in the four tube orifices, configured to receive the locking pin; and
four locking pins, wherein the locking pins lock the first tube frame and the second tube frame into corresponding tube orifices.

14. The nesting utility cart of claim 11, wherein the side walls are configured to be removed for storage, and the nesting utility cart is configured to accept more than one side wall for storage.

15. A system, comprising:
a stack of a plurality of nesting utility carts, each nesting utility cart comprising:
a cart deck having a first portion and a second portion;
at least two wheels each secured to opposing sides of the first portion of the cart deck, and at least two wheels each secured to opposing sides of the second portion of the cart deck;
at least two orifices each through opposing sides of the first portion of the cart deck, and at least two orifices each through opposing sides of the second portion of the cart deck;
wherein the orifices are dimensioned to accept at least a portion of similar wheels of an overlaying similar cart deck;
wherein the at least two orifices in the first portion of the cart deck and the at least two orifices in the second portion of the cart deck are in a position to receive the similar wheels of the similar cart deck;
wherein the overlaying similar cart deck is nested in a reverse manner with respect to the first portion and second portion of the cart deck;
wherein the similar wheels of the similar cart deck nest within the at least two orifices in the first portion of the cart deck and the at least two orifices in the second portion of the cart deck; and
wherein each similar wheel protrudes below a bottom surface of the cart deck.

16. The system of claim 15, at least one cart deck further comprising:
four tube orifices, each configured to receive one end of a first tube frame or one end of a second tube frame, the cart deck including four corners and having one tube orifice located at each corner;
removable side walls including:
the first tube frame comprising a first tube with two ends, with each end of the first tube located in separate tube orifices at the outer corners in at least one of:
the first portion of the cart deck; and
the second portion of the cart deck;
the second tube frame comprising a second tube with two ends, with each end of the second tube located in separate tube orifices at the outer corners in at least one of:
the first portion of the cart deck; and
the second portion of the cart deck;
netting attached in at least one of the following configurations:
between the first tube frame and the second tube frame; and
on at least one of the first tube frame and the second tube frame.

17. The system of claim 15, wherein the stack of the plurality of nesting utility carts is uniform in length and uniform in width.

18. A method comprising:
providing a first nesting utility cart, comprising:
a cart deck having a first portion and a second portion;
at least two wheels each secured to opposing sides of the first portion of the cart deck, and at least two wheels each secured to opposing sides of the second portion of the cart deck;
at least two orifices each through opposing sides of the first portion of the cart deck, and at least two orifices each through opposing sides of the second portion of the cart deck;
wherein the orifices are dimensioned to accept at least a portion of similar wheels of an overlaying similar cart deck;
wherein the at least two orifices in the first portion of the cart deck and the at least two orifices in the second portion of the cart deck are in a position to receive the similar wheels of the similar cart deck;
wherein the overlaying similar cart deck is nested in a reverse manner with respect to the first portion and second portion of the cart deck;
wherein the similar wheels of the similar cart deck nest within the at least two orifices in the first portion of the cart deck and the at least two orifices in the second portion of the cart deck; and
wherein each similar wheel protrudes below a bottom surface of the cart deck;
providing a second nesting utility cart that is substantially similar to the first nesting utility cart;
orienting the second nesting utility cart in the reverse manner to an orientation of the first nesting utility cart;
placing the second nesting utility cart onto the first nesting utility cart such that all of the wheels of the second nesting utility cart protrude below the bottom surface of the cart deck of the first nesting utility cart.

19. The method of claim 18, further comprising:
providing a third nesting utility cart that is substantially similar to the second nesting utility cart;
orienting the third nesting utility cart in the reverse manner to an orientation of the second nesting utility cart;
placing the third nesting utility cart onto the second nesting utility cart such that all of the wheels of the third nesting utility cart protrude below the bottom surface of the cart deck of the second nesting utility cart.

20. The method of claim 18, further comprising removing side walls from at least one of the first nesting utility cart and the second nesting utility cart before placing the second nesting utility cart onto the first nesting utility cart,
wherein at least one of the first nesting utility cart and the second nesting utility cart further comprises:
four tube orifices, each configured to receive one end of a first tube frame or one end of a second tube frame, the cart deck including four corners and having one tube orifice located at each corner;
removable side walls including:
the first tube frame comprising a first tube with two ends, with each end of the first tube located in separate tube orifices at the outer corners in at least one of:
the first portion of the cart deck; and
the second portion of the cart deck;
the second tube frame comprising a second tube with two ends, with each end of the second tube located in separate tube orifices at the outer corners in at least one of:
the first portion of the cart deck; and
the second portion of the cart deck;
netting attached in at least one of the following configurations:
between the first tube frame and the second tube frame; and
on at least one of the first tube frame and the second tube frame.
